(19) United States
(12) Patent Application Publication
(10) Pub. No.: US 2005/0116951 A1
(43) Pub. Date: Jun. 2, 2005

(54) Using runs of cells to traverse a ray through a volume

(76) Inventor: Peter Stephenson, Providence, RI (US)

Correspondence Address: Gordon E Nelson;Patent Attorney, 57 Central Street, P O Box 782, Rowley, MA, 01969, US

(21) Appl. No.: 10/500,772

(22) PCT Filed: Jan. 6, 2003
(86) PCT No.: PCT/US03/00240

(30) Foreign Application Priority Data
Aug. 2, 2002 (US) PCTUS0239176
Jan. 7, 2002 (US) PCTUS0224711

(51) Int. Cl. G06T 17/00

(52) U.S. Cl. 345/424

(57) ABSTRACT

Line drawing techniques that employ runs or runs of runs of pixels to draw the line compute line structure information that they use to determine the sequence of runs in the line. This line structure information may be used to compute the positions of a plurality of the runs and then draw the runs in parallel. The line drawing techniques may be also be used with rays in three dimensions. Projections of the ray are made on planes that intersect each other on the ray's major axis. The line drawing techniques are used to determine cells in the planes that are intersected by the projections. The voxels intersected by the ray are then determined using the cells. Runs of voxels in the ray are used in ray traversals. The volume traversed by the ray is subdivided into encoding runs of voxels that may include one or more significant runs containing voxels whose data will affect the ray. Traversal is done by determining for each run of voxels in the ray whether any of the voxels in the ray run are also in a significant run.

### CROSS REFERENCES TO RELATED APPLICATIONS

The present patent application claims priority from the following applications:
U.S. provisional patent application 60/346,741, Peter Stephenson, Method for visualizing volumetric datasets, filed 7 Jan., 2002;
PCT/US02/24711, Stephenson, et al., Methods and apparatus for determining intersections of a particular line with cells in a lattice filed 2 Aug. 2002; and
PCT/US02/39716, Peter Stephenson, et al., Using line structure information to enhance line drawing in digital systems, filed 12 Dec. 2002
   PCT/US02/24711 claims priority from U.S. provisional patent application 60/309,926, Stephenson, et al., Process and apparatus for line drawing, filed 3 Aug. 2001. PCT/US02/39716 claims priority from U.S. provisional patent application 60/341,503, Stephenson, et al., Process and apparatus for anti-aliased line drawing, filed 13 Dec. 2001, and U.S. provisional patent application 60/341,194, Stephenson, et al., Process and apparatus for line drawing in parallel, also filed 13 Dec. 2001.

In the US national stage, this application will be a continuation-in-part of both PCT/US02/24711 and PCT/US02/39716. This application contains the entire Detailed Description of PCT/US02/24711 and the portion of PCT/US02/39716 titled Parallel techniques for determining the cells of a raster that are intercepted by a line. The material in the Detailed Description, which is new to this application, begins with the section Problems of ray traversal in three dimensions.

### BACKGROUND OF THE INVENTION

1. Field of the Invention

The invention relates generally to techniques for determining which cells of a raster a particular line intersects. The cells of the raster are represented in the memory of a computer system and the computer system's processor makes the determination. The cells of the raster may generally represent a set of locations. The locations may be pixels in a display, and when they are, the techniques may be used to determine which pixels in the display represent the particular line, and thus to generate the line in the display.

2. Description of Related Art

FIGS. 9-11

Systems Using Raster Display Devices: FIG. 9

The flat panel or cathode ray tube display devices typically used with computer systems are raster devices, that is, the display area is made up of a large number of picture elements, or pixels, which are arranged in a grid. The location of any pixel in the display can be specified by its row and column in the grid. Varying the color and intensity of the pixels in the grid makes the image that the display device displays.

FIG. 9 is a high-level overview of a computer system with a raster display device. The main components of system 901 are a processor 911 with memory 903 to which processor 903 has access and a monitor 915 for which processor 911 generates displays. Monitor 915 is a raster display device and as such, has a grid of pixels 917. Within memory 903 are stored bitmap 909, bitmap drawing code 985, and bitmap data 907. Bitmap 909 is an area of memory that corresponds to grid of pixels 917. Each item of data in bitmap 909 corresponds to a pixel in grid of pixels 917. Drawing code 985 is code for drawing graphical entities such as lines or polygons in bitmap 909. Bitmap data 907, finally, is data, typically supplied by a user program, which bitmap drawing code 985 uses to draw a graphical entity. For example, if a user program wishes to specify a line, it will typically indicate the start and end coordinates of the line in grid of pixels 917 and drawing code 985 will use that information to draw a corresponding line in bitmap 909. Processor 911 then reads from bitmap 909 to generate an image for display on grid of pixels 917. In many cases, a display generator component 913 of processor 911 reads bitmap 909 and produces the actual signals for monitor 915 from the data in bitmap 909. It should be noted here that the task of producing a display 917 may be distributed in many different ways across hardware and software components, with the amount of hardware increasing as performance demands increase.

Representing Lines Using Pixels: FIG. 10

Drawing straight lines is a problem with any raster display device. FIG. 10 shows why. FIG. 10 shows a representation in pixels 1001 of the line 1003 that is described by the equation

$$y = \frac{17}{41} x .$$

The representation includes those pixels in the grid that are intersected by line 1003. These pixels form a pattern 1004 that is termed the intersection pattern for the line. A line's intersection pattern depends not only on the line's slope, but also on the location of its endpoints relative to the grid of pixels. As will be explained in more detail in the following, the intersection pattern for any straight line has regular features that can be used in drawing the straight line in a raster display or analyzing a straight line that is displayed in a raster display.

At its lowest level, the intersection pattern for line 1003 is a sequence of pixels. For a given next pixel, there are only two possibilities: if the current pixel has the coordinates (a,b), the next pixel has either the coordinates (a+1,b) or (a+1,b+1). Which of the two possibilities the next pixel has depends on where the line intersects the current pixel. To draw a line one pixel at a time, one need only determine for each pixel where the line intersects the current pixel and use that information to determine which of the two possible positions to give the next pixel.

As is apparent from FIG. 10, the intersection pattern includes groups of adjacent pixels that have the same y coordinate. Such a group of pixels is called a run. One such run of three pixels is shown at 1005. An examination of the runs in FIG. 10 shows that they have only two lengths: a short length 107, which is here two pixels, and a long length 1009, which is here three pixels. The general rule is that the runs of an intersection pattern will have only two lengths, and these lengths will be consecutive integers. The lengths of the long and short runs for any given line can be computed as follows:

Within the intersection pattern of the line l:

$$l \text{:} y = \frac{a}{d} x ,$$

there are a runs that correspond to the Y-axis size of the lattice. As there are only two possible run lengths in a given intersection pattern and the possible lengths are consecutive integers we will refer to the lengths as short (s) and long (l). To determine what run lengths are possible within the intersection pattern, consider that there are d pixels to be distributed among a runs, the distribution being as even as possible. If we divide up the d pixels into a runs of length

$$r = ⌊ \frac{d}{a} ⌋$$

we have n≡d mod a pixels remaining, 0≦n<a, which have to be distributed along the intersection pattern. Therefore in the intersection pattern of l there are n long runs each with r+1 pixels and a−n short runs with r pixels each.

This can be applied to line 1003 as follows: line 1003 contains 41 pixels and 17 runs. The possible run lengths are

$$r = ⌊ \frac{41}{17} ⌋ = 2$$

and r+1=3. There are 41 mod 17≡7 long runs 1009 of length three shown in light gray and 17−7=10 short runs 1007 of length two shown in dark gray. Therefore using a run-based algorithm improves upon pixel-based algorithms as only a and not d decisions whether to increase they coordinate by 1 are necessary.

An examination of intersection pattern 1004 of line 1003 shows that the long and short runs themselves occur in repeating patterns. Thus, in intersection pattern 1004, there is a repeating pattern of a long run (l) followed by two short runs (s) followed by a long run followed by one short run, or lssls, as shown at 1011 and 1013. In general, there are four possibilities for the patterns of runs:
ls⁺, a long run followed by one or more short runs;
l⁺s, one or more long runs followed by a short run;
sl⁺, a short run followed by one or more long runs; and
s⁺l, one or more short runs followed by a long run.

These patterns are termed in the following the shapes of runs. Thus, using this notation, the shape of the runs shown at 1011 and 1013 is ls⁺. Moreover, it turns out that the first run in the intersection pattern of the line l:

$$l \text{:} y = \frac{a}{d} x$$

must be long. Therefore we need only two shapes: ls⁺ and l⁺s to describe the intersection patterns of a line. ls⁺ applies when there are more short runs than long runs in the intersection pattern and l⁺s when there are more long runs than short. In the case where there are equal numbers of runs, the two cases are equivalent.

The properties just described also apply to runs of runs. For example in intersection pattern 1004, the complete sequence of runs is lslslsslslsslslss; therefore we have singularly occurring runs l separating sequences of shorts runs s⁺ and the intersection pattern is constructed of runs of runs with the shape ls⁺. The terminology of runs of runs is cumbersome so let us define these runs of runs to be second order runs. Where a run is defined by its position and length, a second order run is defined by its position, its length is defined by the number of runs which comprise it, and its shape is determined by whether there are more long or short runs in the pattern. By analogy with second order runs, we can define runs to be first order runs and pixels to be zero order runs.

To determine the possible lengths of the second order runs let us consider the case where there are more short runs than long and continue the use of our example. In this case, the number of second order runs must be the same as the number of long runs in the pattern by definition. If there are n long runs in the line there are a runs to divide amongst n second order runs. Therefore, if the division is to be as even as possible the length of a short second order run, r^{[2]}, will be

$${r}^{[ 2 ]} = ⌊ \frac{a}{n} ⌋ .$$

There will be n^{[2]}≡a mod n long runs and a−n^{[2]} short runs of order 2. The second order runs appear at 1011 and 1013 in intersection pattern 1004. There are more short runs 1013 than long, so the second order runs have the shape ls⁺, i.e., one long run followed by a sequence of short runs. There are three long runs 1011 of length three and four short runs 1013 of length two.

There is no reason to end this hierarchical description at order 2. We can define a recursive hierarchical description of the intersection pattern of the line l based on defining runs of higher order. For orders three and above, there is no restriction that the first run in the intersection pattern must be long and therefore all four possible shapes can occur. For order i, if there are more short runs of order i−1 in the intersection pattern, the shape of the order i runs will be s⁺l or ls⁺. If there are more long runs of order i−1, the shape will be l⁺s or ls⁺. An example of third order runs in the intersection pattern 1004 is shown at 1015 and 1017. There are three runs of order 3 amongst which the seven runs of order 2 are to be distributed as evenly as possible. Therefore the length of a short run of order 3 is

$${r}^{[ 3 ]} = ⌊ \frac{7}{3} ⌋ = 2 ,$$

and amongst the three order 3 runs, there will be 7 mod 3≡1 long run of length r^{[3]}+1=3. The shape of the order 3 runs is s⁺l. For lines with a rational slope, the hierarchical description of ordered runs within the intersection pattern will be bounded, as the intersection pattern is eventually repeated if a and d are not coprime.

For the example line 1003 l:

$$l \text{:} y = \frac{17}{41} x ,$$

the process reaches its conclusion at order 4. There are three order 3 runs, of which one is long and two are short. There will be therefore one order 4 run containing all three order 3 runs and starting with the only long order 3 run.

The order 4 run is the entire intersection pattern of the line l:

$$l \text{:} y = \frac{17}{41} x$$

and the lattice [symbol] (41,17).
Dealing with Lines that do not Intersect the Origin: FIG. 11

Introducing a non-zero intercept to a line with rational slope presents a number of complications. Consider the line l:

$$l \text{:} y = \frac{a}{d} x + β$$

where a and d are coprime. Within the frame of the lattice [symbol] (d,a), the line y forms an intersection pattern that is repeated throughout the infinite intersection pattern defined upon the unbounded lattice. Therefore we will only consider the intersection pattern [symbol] within the frame [symbol] (d,a).

Let us consider first the line l:

$$l \text{:} y = \frac{a}{d} x + β$$

where β=0. Within the frame [symbol] (d,a), the vertical distance the line l is above any lattice point within the intersection pattern is

$$\frac{{b}_{j}^{[ 0 ]}}{d}$$

where bⱼ^{[0]}=0, . . . , d−1 where the values bⱼ^{[0]} are those values of the order 0 numerator sequence. The numerator sequence is a sequence of the numerators of the fractions

$$\frac{{b}_{j}^{[ 0 ]}}{d} .$$

These fractions specify the point in the left edge of the pixel at which the line intersects the pixel. Therefore, the line is at least

$$\frac{1}{d}$$

from any lattice point. If the value of β is raised slowly, the intersection pattern will remain unchanged until the line crosses or intersects a lattice point. Therefore, the first change will occur when

$$β = \frac{1}{d} .$$

Let the lattice point intersected be (xₕ, yₕ).

As the line l:

$${l}^{′} \text{:} y = \frac{a}{d} x + β$$

intersects the point (xₕ,yₕ) and the line l:

$$l \text{:} y = \frac{a}{d} x$$

intersects the origin, the intersection pattern [symbol] of the line l′ will be identical to the intersection pattern [symbol] of the line l translated by (xₕ, yₕ). Therefore the introduction of an intercept to a line with rational slope will, more often than not, cause a shifting of the intersection pattern of the line. The key values of the intercept at which this translation of the intersection pattern occurs are

$$β = \frac{1}{d}$$

where b=0, . . . , d−1.

FIG. 11 gives an example. At 1001, the figure shows the intersection pattern of the line l:

$$l \text{:} y = \frac{17}{41} x .$$

At 1101, the figure shows the effect of introducing an intercept value of

$$\frac{23}{41}$$

on the interception pattern. The numerator sequence for order 0 of 1001 is shown at 1109 and that for order 0 of 1101 at 1111.

Given that the numerator of the intercept is b=23, we have demarcated the pixels before (1103) and after (1104) b=23 in order 0 numerator sequence 1109 by a dashed line 1102. The pixels 1104 to the right of this value are denoted by light gray and the pixels 1103 to the left by dark gray. At 1101, we can see that adding the intercept value

$$\frac{23}{41}$$

shifts the light gray pixels 1104 to the beginning of the intersection pattern, [symbol] The dark gray pixels 1103 now form the end of the pattern [symbol] Coinciding with the shift in pixels, the values of numerator sequence of order 0 1111 are also shifted and now start with a value of b₀^{[0]}=b=23. The shifting of the runs of all orders in the intersection pattern with the introduction of a non-zero intercept is mimicked by the shift in the values of the numerator sequence.

The shifting of the intersection pattern due to the introduction of a non-zero intercept has a number of side effects. The initial and final run of any order may be truncated. This occurs when the numerator of the intercept is not in the numerator sequence of that order. A run order is split and forms the initial and final partial run. If the numerator sequence is to be calculated for this order, the initial numerator value will have to be calculated. For example, at 1101, the numerator value of the intercept is b=23. We know that all of the numerator values of order 1 are less than p^{[1]}=a=17. Therefore the initial value of the order 0 numerator sequence will not be the same as the initial value of the order 1 numerator sequence and the initial and final runs of order 1 will be truncated.

Using Hierarchies of Runs to Generate Lines

There are many line drawing techniques that take advantage of the structure of a line's intersection pattern. At the pixel level, the standard line drawing algorithm of Bresenham may be employed. In this algorithm, the point at which the line intersects the current pixel determines whether the next pixel's y coordinate is incremented by 1. See J. E. Bresenham, “An incremental algorithm for digital plotting”, ACM National Conference, August 1963. Bresenham's algorithm may be used only with lines whose start and end coordinates are rational numbers. Where the starting and end coordinates may be any real number, the well-known DDA algorithm must be used. See A. Van Dam, J. Foley, S. Feiner and J. Hughes, Computer Graphics: Principles and Practice, Second Edition in C, Addison-Wesley (1995). Like Bresenham's algorithm, DDA works at the pixel level. Initially, floating-point x and y increments are computed. The x increment is the difference between the ending and starting x coordinates divided by the line's length and the y increment is the difference between the ending and starting y coordinates divided by the line's length. Each time a pixel is set, the current x and y coordinates, which are floating point values, are converted to integers and the pixel is set at the cell defined by the increment. Then the x increment is added to the x coordinate and the y increment is added to the y coordinate. A difficulty with any pixel-by-pixel approach is that it requires a determination where the next pixel will be placed relative to the last pixel for each new pixel. With the DDA algorithm, this determination is a floating-point operation. As such, it is both expensive to perform and subject to rounding errors. Moreover, because the determination must be performed with every pixel, the rounding errors may accumulate quickly and cause the line to be drawn inaccurately.

The overhead of computing the location of the next pixel relative to the last is avoided in algorithms that use runs of pixels instead of individual pixels to draw the line. At the level of a run of order 1, Reggiori has developed an algorithm that determines the length of the next run in the line from the set of two possibilities. See G. B. Reggiori, “Digital computer transformations for irregular line drawings”, Technical Report 403-22, New York University, April 1972. Stephenson generalizes these techniques to the full hierarchy of runs in the line including runs of runs, runs of runs of runs, etc. See P. Stephenson, The structure of the digitized line, Ph.D thesis, James Cook University of North Queensland, 1998, which is incorporated by reference herein. Like Bresenham's algorithm, the algorithms that use runs and run hierarchies are limited to lines whose start and end points have rational number coordinates.

All of these algorithms possess a similar conditional structure regardless of whether they are based on pixels such as Bresenham's pixel-based algorithm or the DDA algorithm, runs such as Reggiori's algorithm, or a mixture of runs and runs of runs such as the run-length-slice algorithms. The slopes that are considered are bounded to lie in the range 0<α<1. For pixel-based algorithms, that limits the choice of the next pixel to a possible set of two. For run-based algorithms, the choice is made between the two possible run lengths that can exist in the line. In all of these algorithms, the choice is made by checking the value of a decision parameter against the value of zero. For values less than zero, one element of the possible set of choices is used; for values greater than zero, the other choice. For a value of zero, each technique handles this case differently. For line drawing applications, either choice is equally applicable and for ray tracing, this typically signifies a corner intersection.

Run-based line drawing may also be used to solve problems that arise in efficiently representing rays that traverse three-dimensional space and in speeding traversal of the three-dimensional space by such a ray. It is an object of the present invention to provide solutions to such problems.

### SUMMARY OF THE INVENTION

In one aspect, the invention is a technique employed in a computer system for determining voxels in an object space that are intersected by a ray. Broadly stated, the technique involves making projections of the ray on a plurality of planes in the object space, determining cells in the planes that are intercected by the projections, and using the intersected cells to determine the intersected voxels. Determining which cells are intercepted by the projections may be done using runs of cells, as explained in the parents of the present application, and runs of order 1 or greater may be employed. The plurality of planes may be a pair of intersecting planes which are perpendicular to each other and for which the line of intersection is the ray's major axis.

Further details of this aspect include techniques for determining intersected voxels that are 26-connected and intersected voxels that are only six-connected. In the 26-connected case, the technique proceeds as follows at the beginning of the next run of voxels:
if the first order runs of cells that include the points in the projection corresponding to the beginning of the next run of voxels end at the same coordinate of the ray's major axis, the first order runs of cells together determine the next run of voxels through the end of the first order runs; but
if the first order runs do not end at the same major axis coordinate, the shorter first order run of cells and the corresponding portion of the longer of the first order runs of cells determine the next run of voxels.

In the 6-connected case, the above basic technique is used, but an extra cell is added to the beginning of a first order run of cells prior to using the first order run of cells to determine a run of voxels.

Further, this aspect includes techniques for determining from the runs of cells whether the voxels intersected by the ray have edge or corner connections. The voxels will have an edge connection if one of the first order runs of cells has a corner connection at a point and the other does not; if both of the first order runs of cells have a corner connection at the point, the intersected voxels have a corner connection.

In another aspect, the invention is a technique employed in a computer system of efficiently traversing a volume with a ray. The volume is subdivided into runs of voxels. Certain of the voxels in the runs are associated with data that affects rays. Each ray that traverses the volume intersects one or more of the first runs and it itself made up of a set of second runs of voxels. The technique determines for a second run of voxels belonging to a particular ray whether the second run includes a voxel of a first run that affects rays. When the second run includes such a voxel, the data associated with the voxel is examined. It is advantageous for the technique if the volume has an axis which is the major axis for both the particular ray and the first runs of voxels and if there are three sets of first runs, each set having a different axis of the volume as its major axis. Continuing in more detail with this aspect, the first runs contain significant runs that include voxels that affect rays. Determining whether the second run includes a voxel from a first run that affects rays includes determining whether the second run includes a voxel of a significant run.

In other details, aggregate information is associated with partitions of the first runs. The aggregate information indicates how one or more of the voxels in the partition affect rays. Determining whether the second run includes a voxel from a first run that affects ways includes using the aggregate information associated with a partition determine whether the partition contains a voxel that affects the particular ray. The partitions may be the significant runs. They may also be a number of sets of partitions, with the partitions in each set having a different length. The partitions to use for a particular ray are selected in accordance with the lengths of the runs in the ray.

Other objects and advantages will be apparent to those skilled in the arts to which the invention pertains upon perusal of the following Detailed Description and drawing, wherein:

### BRIEF DESCRIPTION OF THE DRAWING

FIG. 1 is an overview of the manner in which lines are drawn using the techniques of the invention;

FIG. 2 is an overview of a system which draws lines using the techniques of the invention;

FIG. 3 is a flowchart of how the bitmap processor processes complete runs of pixels;

FIG. 4 is a flowchart of how the bitmap processor processes truncated runs of pixels;

FIG. 5 is a flowchart of how the bitmap processor processes a ran of order 1;

FIG. 6 is a flowchart of how the first truncated run of an order i is processed and set;

FIG. 7 shows how the first pixel of a line is handled using the techniques of the invention;

FIG. 8 shows a flowchart of how a complete run of order i is processed;

FIG. 9 shows a system in which the invention may be employed;

FIG. 10 shows the structure of a representation of a line as a set of pixels;

FIG. 11 shows the effect of a displacement of the starting point from the origin on the structure of the representation;

FIG. 12 shows an example line;

FIG. 13 shows how the first pixel of the example line is handled;

FIG. 14 shows truncated runs of orders 1-3 in the example line;

FIG. 15 shows the geometry of the error term and structural parameters in a run of order 1;

FIG. 16 is a flowchart of a technique for drawing lines in parallel;

FIG. 17 is a diagram showing the geometry of ray traversal;

FIG. 18 is a diagram showing the geometry of the projection of a ray on planes that are perpendicular to each other and intersect at the ray's major axis;

FIG. 19 is a first diagram showing how voxels intersected by a ray may be computed from the cells intersected by the ray's projections;

FIG. 20 shows an algorithm for computing the voxels intersected by a ray;

FIG. 21 is a second diagram showing how voxels intersected by a ray may be computed;

FIG. 22 is a third such diagram showing how edge connections appear in the projections;

FIG. 23 is an algorithm for detecting edge connections in the voxels;

FIG. 24 is a fourth diagram showing how corner connections appear in the projections;

FIG. 25 is an algorithm for detecting corner connections in the voxels;

FIG. 26 is a diagram showing an encoding run in a volume;

FIG. 27 shows a ray traversing a volume which has been divided into encoding runs;

FIG. 29 shows an algorithm for detecting an intersection between a ray and an encoding run;

FIG. 30 shows a ray traversing a volume in which the encoding runs have been divided into a hierarchy of runs; and

FIG. 31 shows an algorithm for using a hierarchy of runs to find voxels that will affect the ray.

### DETAILED DESCRIPTION

As indicated in the section Cross references to related applications, this application contains the entire Detailed Description of PCT/US02/24711 and the portion of PCT/US02/###### titled Parallel techniques for determining the cells of a raster that are intercepted by a line. The material in the Detailed Description, which is new to this application, begins with the section Problems of ray traversal in three dimensions.

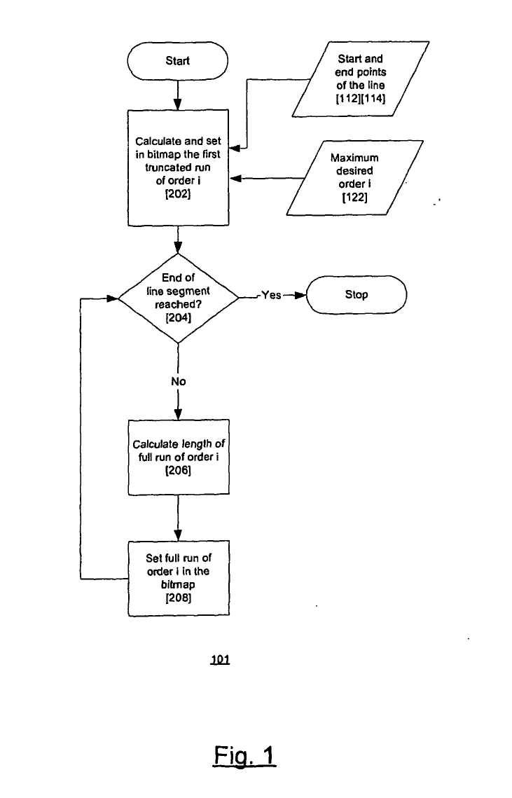

Overview of Line Drawing with the Invention: FIG. 1

FIG. 1 is a flowchart [101] that provides an overview of how a line-segment may be drawn using this invention. Starting parameters include the maximum order of the runs to be used in drawing the lines [122] and the start and endpoints of the line [112,114]. The maximum order can be predefined by the manufacturer of an apparatus based on the invention, calculated based on the characteristics of the system or based on the length of the line. In the preferred embodiment, the maximum order of the runs [120] is set to two.

The line segment defined between the starting point [112] (x₀, y₀) and the end point [114] (x₁, y₁) consists of, at most, three sets of runs of any order, i: The first truncated run of order i, the set of full-length runs of order i, and the final truncated run of order i. To draw the line segment from (x₀, y₀) to (x₁, y₁), we will describe how to calculate and set in the Bitmap Memory [108]:
The first truncated run of order i [202].
The full length runs of order i [206].
The final truncated run of order i while setting the full length runs of order i [206].

An alternative embodiment would calculate the first truncated run, each full length run and the final truncated run separately. Another alternative embodiment would have a desired maximum order [120] of infinity, and therefore the processing of the first truncated run length would draw the entire line segment unless the maximum depth of the hierarchy of runs was reached.

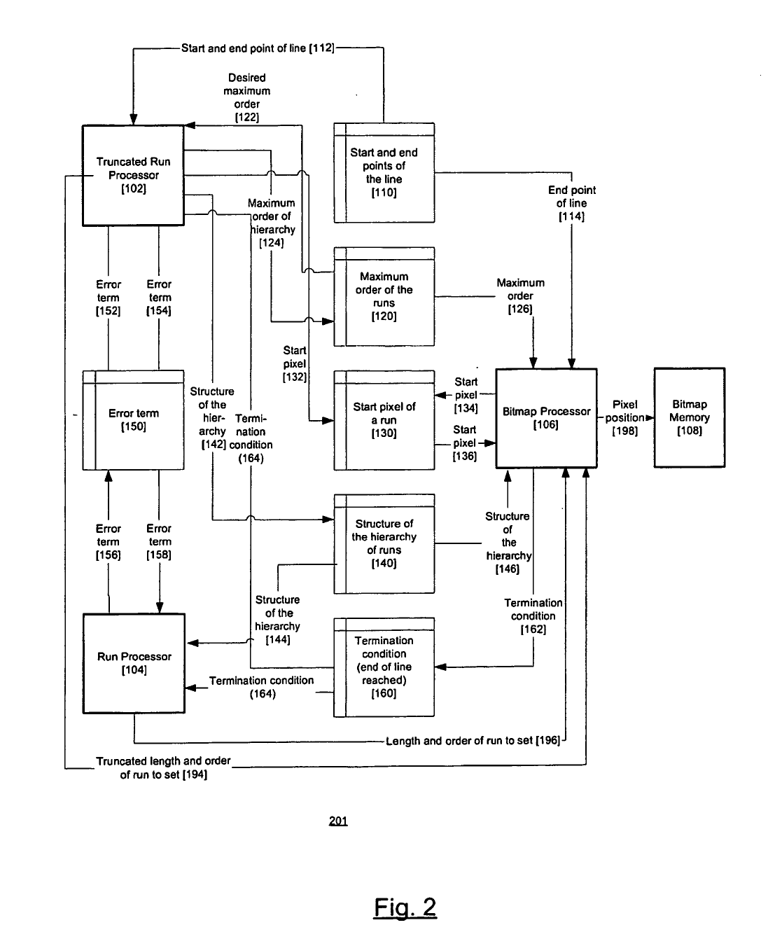

Overview of the Components of a System for Drawing Lines According to the Invention: FIG. 2

FIG. 2 shows the components of a system 201 for drawing lines according to the invention. The main components of system 201 are a Truncated Run Processor [102], which calculates the structure of the first truncated run of order i [202] and the structure of the hierarchy of runs [140] in the line segment, and the Run Processor [104], which calculates the length of the full length runs and the final truncated run [206]. To set the runs [202][208] into the Bitmap Memory [108], the description of each run is given to the Bitmap Processor [106]. The Bitmap Processor is responsible for breaking the run into its composite pixels and setting each pixel into the Bitmap Memory [108].

Truncated Run Processor [102]

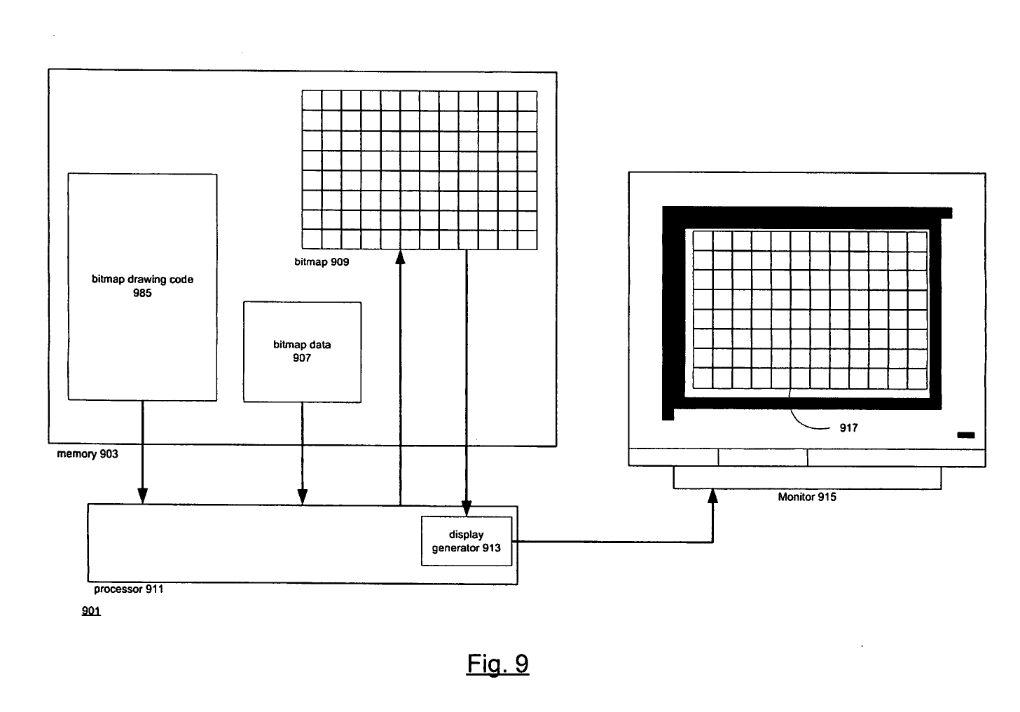

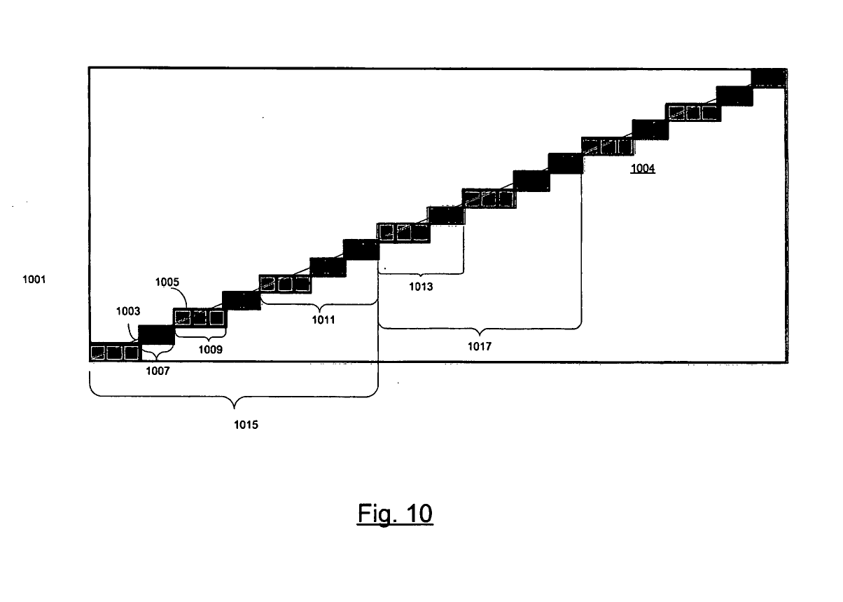

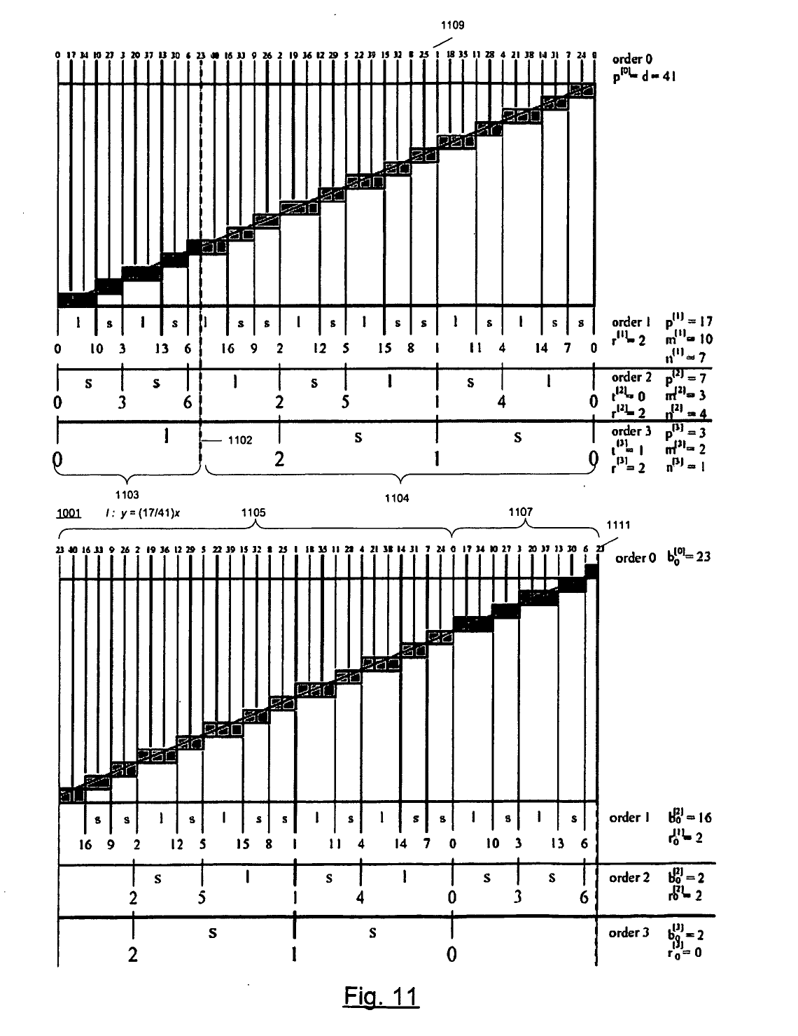

The Truncated Run Processor [102] is responsible for calculating the structure of the first truncated run of the desired order [120] and supplying this structure to the Bitmap Processor [106] so that the truncated run [194] can be set into the Bitmap Memory [108]. Bitmap memory [108] may be a bit map such as bitmap 909 in FIG. 9.

While the Truncated Run Processor calculates the structure of the first truncated run, it also calculates the structure of the hierarchy of runs [140] and stores this information [142] for the use by the Run and Memory Processors [104,106]. During this process if the desired maximum order of the process [120] is found to be greater than the maximum order of the hierarchy of runs in the line, the maximum order [120] is set to be the maximum depth of the hierarchy [124].

Based on the start and end points of the line [110], the Truncated Run Processor also calculates and stores [132] the starting pixel position for the line [130].

Each component of the first truncated run is calculated based on the error term [150]. As each component is processed, the error term is retrieved [152], updated and stored again [154]. Once the first truncated run has been processed, the error term remaining [150] is used by the Run Processor [104] to define the full-length runs in a similar manner.

Run Processor [104]

The Run Processor [104] is responsible for calculating the length of each full-length run of the desired maximum order in the digital line. These lengths are passed to the Bitmap Processor [106] such that the runs can be set into the Bitmap Memory [108]. The length of the full-lengths is decided based on the error term [150], which is retrieved [156], updated and stored [158] to process the next full-length run. Thus, the error term is recalculated only at the beginning of each full-length run of the maximum order instead of for each pixel.

Bitmap Processor [106]

The Bitmap Processor [106] is responsible for actually setting the runs into the Bitmap Memory [108].

We assume there is a method to set a pixel of the memory to a desired value, similar to the setPixel (x, y, value) method described in the prior art. If a method to set a run of higher order, the Bitmap Processor [106] can take advantage of this function.

The Bitmap Processor [106] also keeps a track of the current position of the line being drawn in relation to the end point of the line [110]. If the line moves reaches the end point [114], the Bitmap Processor [106] signals the Truncated Run Processor [102] or the Run Processor [104] to terminate [162] using an internally stored termination condition [160].

Bitmap Memory [108]

The Bitmap Memory [108] is the memory representing the raster display of a graphics system, video memory, image memory or any other type of bitmap.

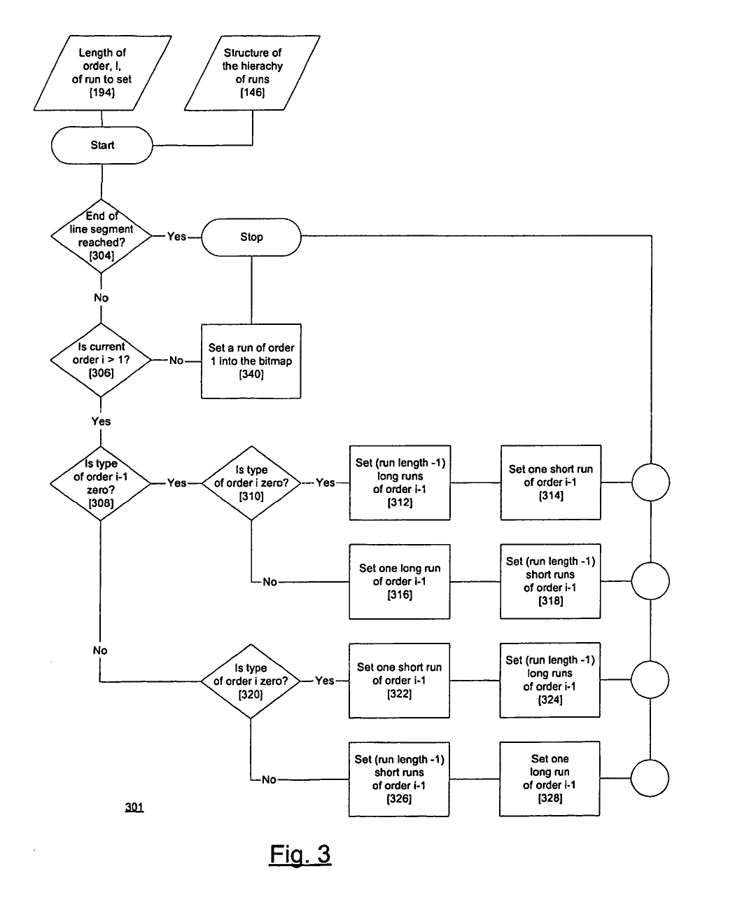

Details of Operation of the Components of System 201: FIGS. 3-8

For the remainder of this description we will describe:
1. How a truncated or full-length run of order i [202][208] is set into the Bitmap Memory [108] via the Bitmap Processor [106].
2. How the first truncated run of order i in the line segment is processed [202] by the Truncated Run Processor [102].
3. How the full-length runs of order i in the line segment [208] are processed by the Run Processor [104].
   How a Run of Order i is set into the Bitmap Memory via the Bitmap Processor: FIG. 3

The Bitmap Processor [106] handles the process of setting the pixels of the Bitmap Memory [108]. To draw the line, the Bitmap Processor is given a set of commands [194][196] to draw a collection of runs of various orders into the Bitmap Memory. The information given in the command to draw a run is the length of the run, rⱼ^{[i]}, and the order of the run, i [194][196]. The position of the run in the bitmap [130], (xⱼ^{[i]}, yⱼ^{[i]}), is initialized [132] by the Truncated Run Processor [102] and is retrieved by the Bitmap Processor [136]. As the run is drawn, the coordinate is updated to the position of the next run of order i, and is stored for the next iteration [134].

The process of setting a run in the Bitmap Memory, involves reducing the run to a set of pixels and setting each individual pixel in the Bitmap Memory. Reducing the run of order i into runs of order 0 (pixels) is performed by recursively reducing the run of order k to runs of order k−1 for each order from k=i to k=2 resulting in a description of the run of order i in terms of runs of order 1. Each pixel in the run of order 1 is then set into memory.

We therefore describe:
How a full-length run of order i is reduced into runs of order i−1.
How the first truncated run of order i is reduced into runs of order i−1.
How the pixels of a run of order 1 are set into the Bitmap Memory.

In an alternative embodiment, if the Bitmap Memory [108] permits the setting of runs of pixels or runs of runs, etc., the process of reducing the run of order i to runs of order i−1 can be stopped at the permitted level. Therefore, instead of setting pixels into the Bitmap Memory, runs or runs of runs can also be used.

Reducing a Full-length Run of order k into Runs of Order k−1: FIG. 3

As described in the Description of related art, each run of any nonzero order i within the digital line has, at most, only two possible run lengths that are consecutive integers where the length is measured as the number of composite runs of the next lowest order, i−1. As a consequence of this, we can denote the occurrence of a short run by the symbol s and a long run by the symbol l. For example the runs of order 1 in the line segment (0, 0) to (41, 17) can be described by (lslslsslslsslslss)^{[1]}.

A run of order i can then be defined recursively by:
A run of order 1 is the maximal set of contiguous pixels with a similar abscissa.
A run of order i is the maximal set of contiguous runs of order i−1 such that each run has a shape (l⁺s)^{[i-1]}, (ls⁺)^{[i-1]}, (s⁺l)^{[i-1l} , or (sl⁺)^{[i-1]}, where (l⁺)^{[i-1]} and (s⁺)^{[i-1]} denote the occurrence of one or more long and short runs of order i−1 respectively.

We note that a run of order 2 can only possess the shape (l⁺s)^{[1]} or (ls⁺)^{[1]}.

Each run of any given order in the line segment has the same shape. To determine for a given order which of the four shapes is to be used, we define the runs of each order to have a type, t^{[i]}, which has a value 0 or 1. For a run of order i:
If t^{[i-1]}=0 and t^{[i]}=0 the shape of the run of order i is s^{[i]}=0: l⁺s.
If t^{[i-1]}=0 and t^{[i]}=1 the shape of the run of order i is s^{[i]}=1: ls⁺.
If t^{[i-1]}=1 and t^{[i]}=0 the shape of the run of order i is s^{[i]}=2: sl⁺.
If t^{[i-1]}=1 and t^{[i]}=1 the shape of the run of order i is s^{[i]}=3: s⁺l.

The type of order 1, t^{[1]}, is defined to be zero. The types of orders greater than 1 are calculated using structural parameters; the structural parameters and their calculation will be described in detail below.

To reduce a run of order i to the composite runs of order i−1, the procedure 301 shown in FIG. 3 is followed.

Inputs to the process are the length of the run of order i to be set [194] and the structure of the hierarchy of runs. The process will cease if the end point of the line has been reached [304].

If the order of the run is 1 [306], the pixels of the run are set directly [340] into the Bitmap Memory.

If the order of the run is at least 2, the run is reduced into its composite runs of the next lesser order and each run is set into the Bitmap Memory:
If t^{[i-1]}=0 and t^{[i]}=0 the shape of the run is s^{[i]}=0: l⁺s, therefore we set in order rⱼ^{[i]}−1 long runs of order i−1 (length rₗ^{i-1]}=rₛ^{[i-1}+1) and one short run of order i−1 (length rₛ^{[i-1]}).

This process follows the path from [308], [310], [312], [314].

If t^{[i-1]}=0 and t^{[i]}=1 the shape of the run is s^{[i]}=1: ls⁺, we set one long run of order i−1 (length rₗ^{[i-1]}=rₛ^{[i-1]}+1) and rⱼ^{[i]}−1 short runs of order i−i (length rₛ^{[i-1]}).

This process follows the path from [308], [310], [316], [318].
If t^{[i-1]}=1 and t^{[i]}=0 the shape of the run is s^{[i]}=2: sl⁺, we set one short run of order i−1 (length rₛ^{[i-1]}) and rⱼ^{[i]}−1 long runs of order i−1 (length rₗ^{[i-1]}=+1).

This process follows the path from [308], [320], [322], [324].
If t^{i-1]}=1 and t^{[i]}=1 the shape of the run is S^{[i]}=3: s⁺l, we set rⱼ^{[1]}−1 short runs of order i−1 (length rₛ^{[i-1]}) and one long run of order i−1 (length rₗ^{[i-1]}=rₛ^{[i-1]}+1).

This process follows the path from [308], [320], [326], [328].

The type and length of the short and long runs of any order are stored in the structure of the hierarchy of runs [146].

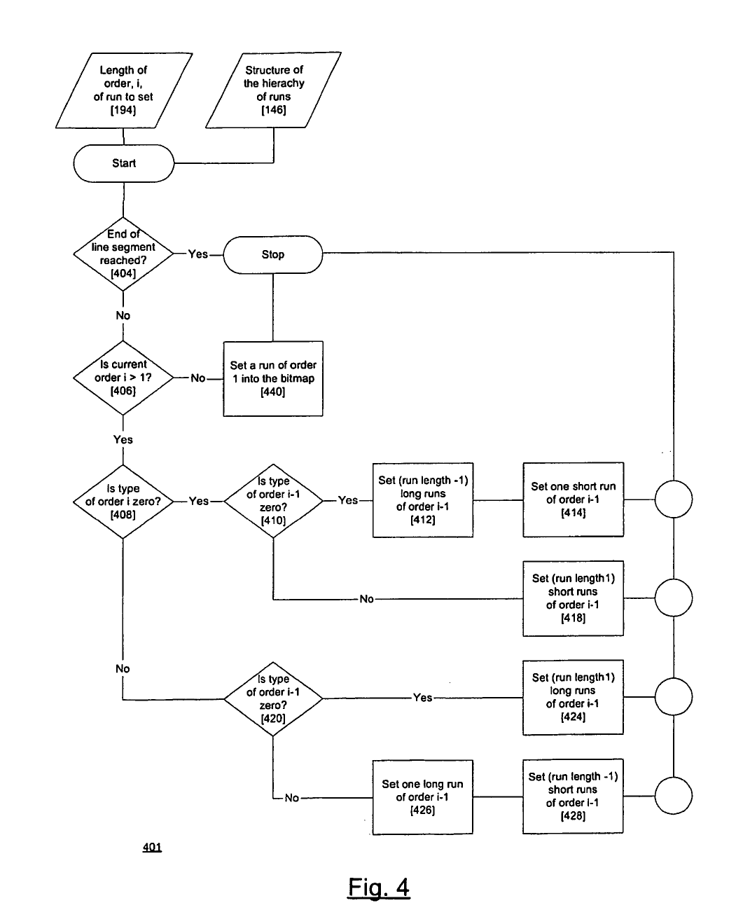

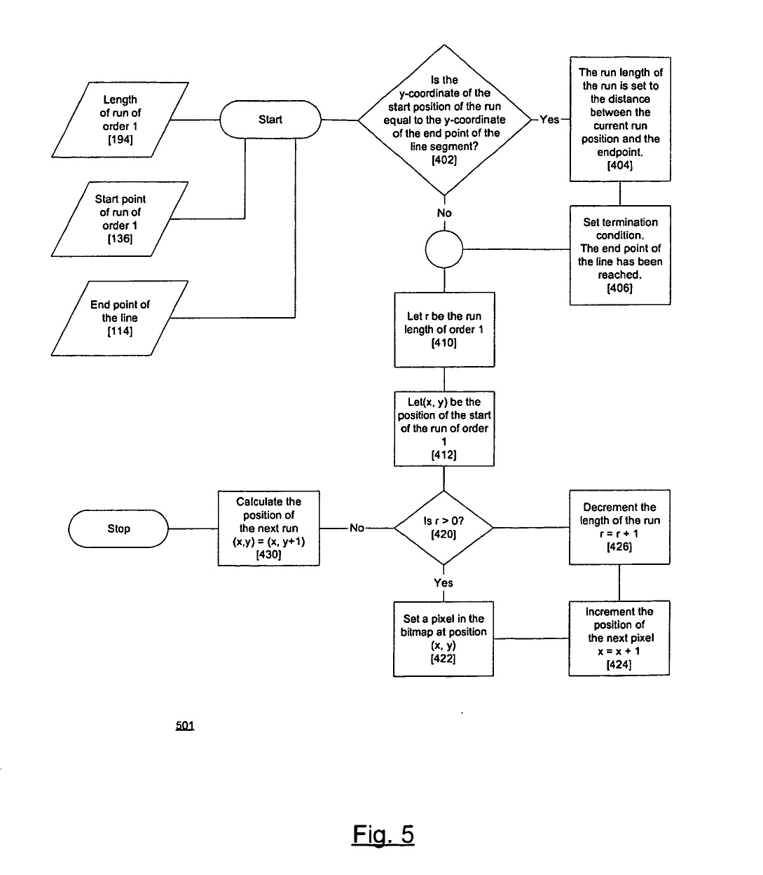

Reducing the First Truncated Run of Order k into Runs of Order k−1: FIG. 4

The process of reducing the first truncated run of order k into full-length runs of order k−1 follows directly from the instructions to reduce full-length runs. The only variation comes from the fact that a truncated run is defined to be a run not of its full-length. Therefore at least one run of order k−1 has been truncated from the run of order k. Because this is the first run in the line, the truncated run occurs at the beginning of the run. In a preferred embodiment, the truncated runs received by the Bitmap Processor have a length of at least one. Therefore the only situations that need to be handled differently are when shapes s^{[i]}=1: ls⁺ and s^{[i]}=2: sl⁺ occur.

The process is shown at 401 in FIG. 4. As with the process for a full-length run, the inputs are the length of the run of order i that is to be set [194] and the structure of the hierarchy of runs [146]. The process 401 will cease if the end point of the line has been reached [404].

If the order of the run is 1 [406], the pixels of the run are set directly [440] into the Bitmap Memory.

If the order of the run is at least 2, the run is reduced into its composite runs of the next lesser order and each run is set into the Bitmap Memory:
If t^{[i-1]}=0 [408] and t^{[i]}=0 [410], the shape of the run is s^{[i]}=0: l⁺s. As the run is truncated, at least one run of order i−1 is removed from the beginning of the run. As the length of the truncated run is r₀^{[i]}, this leaves r₀^{[i]}−1 long runs of order i−1 and the final short run of order i−1. For example if the first run at full length is the sequence of runs (lllls)^{[i-1]} and the initial truncated run length is r₀^{[i]}=3, the truncated run comprises two long runs and the final short run of order i−1: (lls)^{[i-1]}. Therefore to set the initial truncated run length, we set in order r₀^{[i]}−1 long runs of order i−1 (length rₗ^{[i-1]}=rₛ^{[i-1]}+1) [412] and one short run of order i−1 (length rₛ^{[i-1]}) [414].
Similarly, if t^{[i-1]}=0 [408] and t^{[i]}=1 [410], the shape of the run is s^{[i]}=1: ls⁺. The truncated run has less runs than a short run of order i, therefore given the shape of the run ls+, there can only be short runs of order i−1 comprises the truncated run. Therefore we set r₀^{[i]} short runs of order i−1 (length rₛ^{[i-1]}) [418].
If t^{[i-1]}=1 [408] and t^{[i]}=0 [420] the shape of the run is s^{[i]}=2: sl⁺, we set r₀^{[i]} long runs of order i−1 (length rₗ^{[i-1]}=rₛ^{[i-1]}+1) [424].
If t^{[i-1]}=1 [408] and t^{[i]}=1 [420] the shape of the run is s^{[i]}3: s⁺l, we set r₀^{[i]}−1 short runs of order i−1 (length r_{S}^{[i-1]}) [426] and one long run of order i−1 (length rₗ^{[i-1]}=rₛ^{[i-1]}+1) [428].

The type and length of the short and long runs of any order are stored in the structure of the hierarchy of runs [146].

Setting the Pixels of a Run of Order 1 into the Bitmap Memory: FIG. 5

FIG. 5 is a flowchart 501 showing how to set the pixels of a run of order 1 [340]. The method requires as inputs the starting pixel [136], (xⱼ^{[1]}, yⱼ^{[1]}), the end point of the line [114], and the length of the run [194], rⱼ^{[1]}), are required. The starting pixel is stored and updated internally [136]. The length of the run [194] is passed to the Bitmap Processor.

Each pixel in the run has a similar y-coordinate, which is the y-coordinate of the starting pixel [136], yⱼ^{[1]}.

If the y-coordinate for the run being set is the same as the floor of the y-coordinate of the end point of the line, yⱼ^{[1]}=└y₁┘, the run being set is the last run in the line [402]. In this case:
The termination condition [160] signaling that the end point of the line has been reached is set [406].
The length of the run to be set [194] is changed to the difference between the x-coordinate of the start of the run being set and the ceiling of the x-coordinate of the endpoint of the line, rⱼ^{[1]}=┌x₁┐−xⱼ^{[1]} [404].
The run of pixels of length rⱼ^{[1]}=┌x₁┐−xⱼ^{[1]} is set in the Bitmap Memory at location (xⱼ^{[1]}, yⱼ^{[1]}).

To set each of the pixels in the run into the Bitmap Memory, for each of the pixels in the run [410][420][426] starting at the pixel (xₖ^{[0]}, yₖ^{[0]})=(xⱼ^{[1]}, yⱼ^{[1]}) [412]:
Set the pixel (xₖ^{[0]}, yₖ^{[0]}) into the Bitmap Memory [422].
Move to the position of the next pixel,

$$( {x}_{k + 1}^{[ 0 ]} , {y}_{k + 1}^{[ 0 ]} ) = ( {x}_{k}^{[ 0 ]} + 1 , {y}_{k}^{[ 0 ]} ) . \qquad [ 424 ]$$

Once every pixel in the run has been set into the Bitmap Memory, the starting coordinate of the next run of order 1 in the line is calculated from the current coordinate value by incrementing the current y-coordinate of the next pixel position

$$( {x}_{j + 1}^{[ 1 ]} , {y}_{j + 1}^{[ 1 ]} ) = ( {x}_{k}^{[ 0 ]} , {y}_{k}^{[ 0 ]} + 1 ) .$$

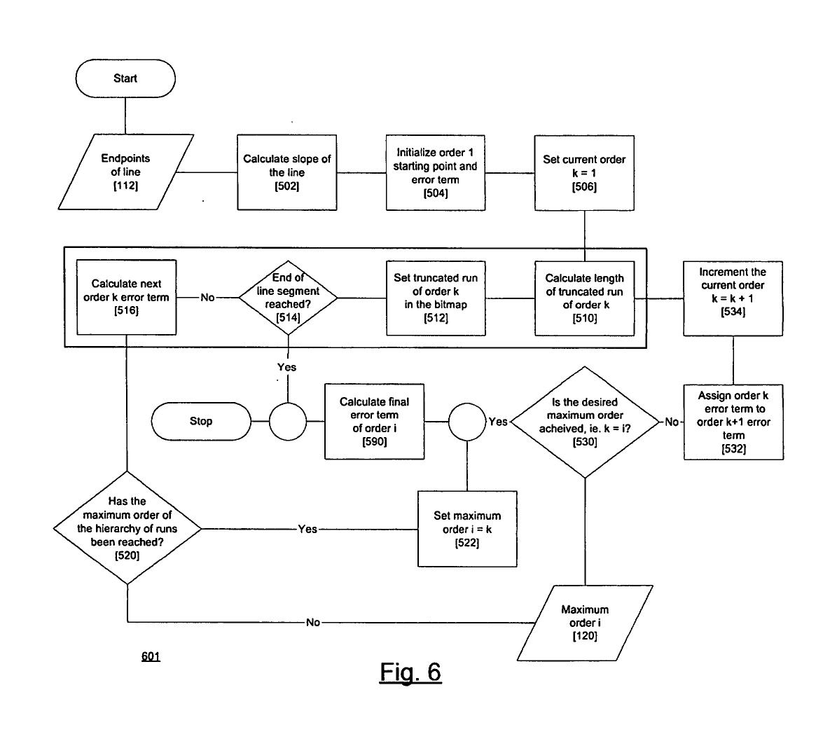

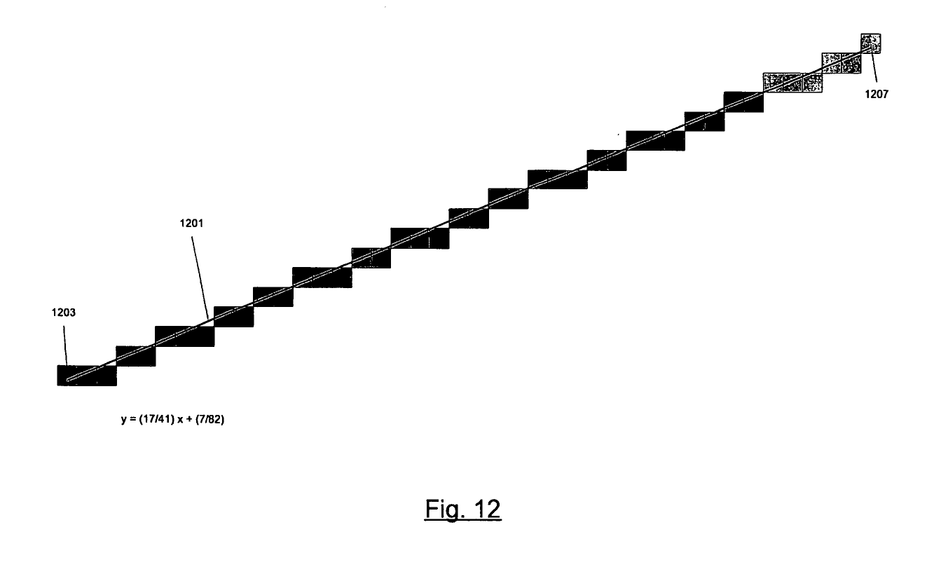

How the First Truncated Run of Order i in the Line Segment is Processed by the Truncated Run Processor: FIGS. 6 and 12

To calculate the length of the initial truncated run length of the maximum order i [120] we calculate and set in the Bitmap Memory each initial truncated run length of order 1 to i in turn. This is shown in flowchart 601 of FIG. 6. If no truncated run length exists for any order, none is set. The process stops if:
The endpoint of the line [110] is reached [514].
The maximum depth of the hierarchy is reached [520].
The desired maximum order is reached [530].

A truncated run length of order k is of course made up of run lengths of orders 0 through k−1. In the above technique, the orders 1 through k are processed beginning with order i=1 and moving order by order to i=k. With each of the orders, the bits for that order are set before the next higher order is processed. For a given order i, the bits set for order i−1 will always make up the complete truncated or untruncated first run of the order i.

Initialize the Slope of the Line [502].

The endpoints of the line segment are the real number coordinates (x₀, y₀) and (x₁, y₁) [112], such that x₀≦x₁ and y₀≦Y₁, therefore the slope of the line, α, has a value between zero and one, 0≦α<1.

The slope of the line is calculated by α=(y₁−y₀)/(x₁−x₀) [502]. In example line 1201 of FIG. 12, the equation of the line is y=17x/41+7/82, therefore α=17/41. Example line 1201's endpoint (x₀, y₀) 1203 is (1/2,12/41); its endpoint (x₁, y₁) 1207 is (41+1/2,17+12/41). Note that while the coordinates of the endpoints are rational numbers in this case, a coordinate may be any real number.

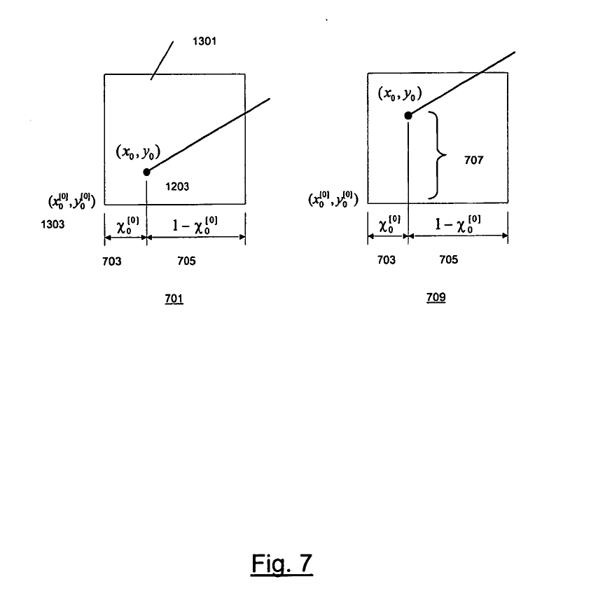

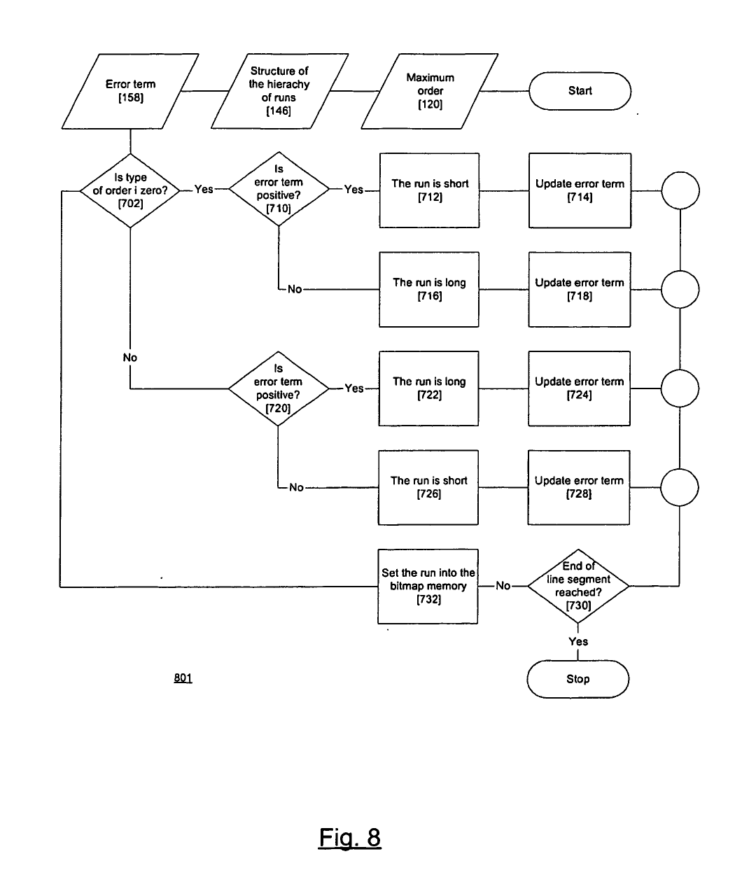

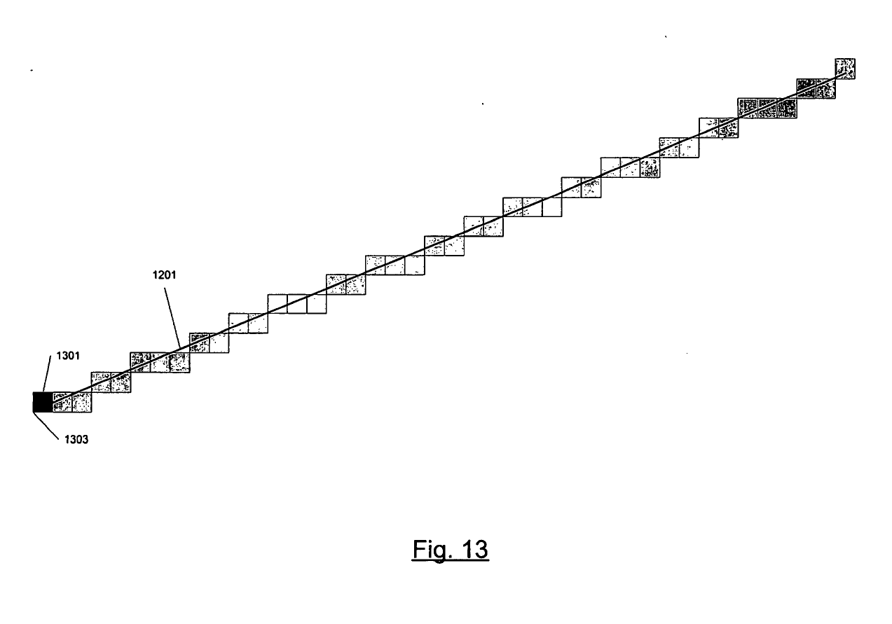

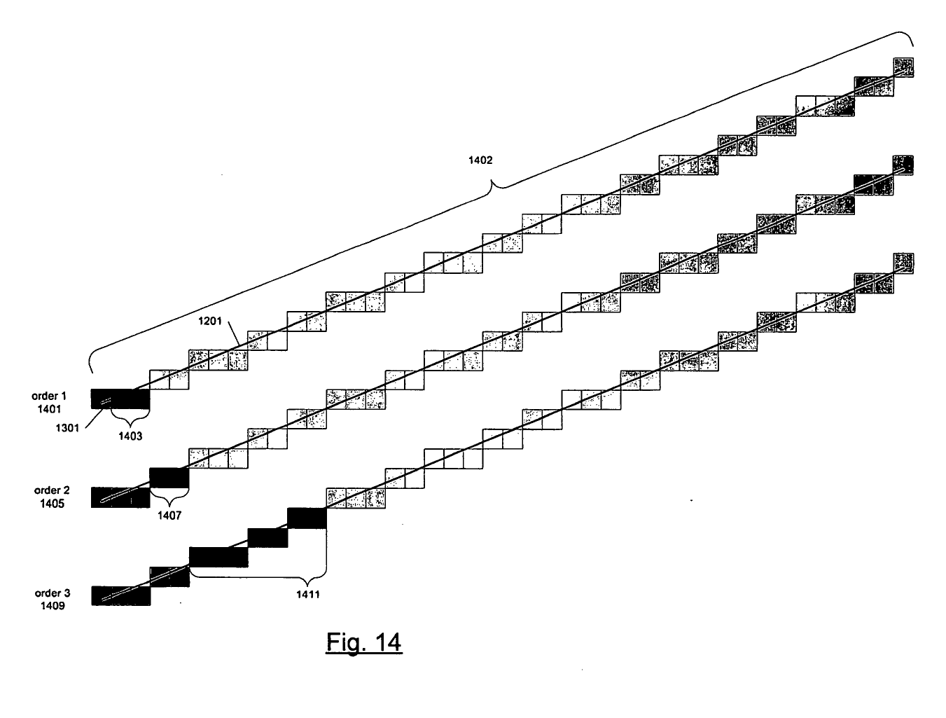

Initialize Order 1 Starting Pixel and Error Term [504]: FIGS. 7 and 13

The first step in the algorithm is to handle the pixel in which the start point of line lies as described in FIG. 13. At the completion of this step, the dark pixel 1301 at the start of the line will have been processed.

As may be seen from FIG. 13, the coordinates of the lower left-hand corner 1303 of pixel 1301 that contains the start point 1203 of line 1201 is:
x₀^{[0]}=└1/2┘=0
y₀^{[0]}=└12/41┘=0

To decide whether to set the first pixel in the line separately from the first run we define the distance X₀^{[0]} 703 from the start point of the line to the beginning of the pixel as described in FIG. 7:
X₀^{[0]}=x₀−x₀^{[0]}
or 1/2 in our example. If x₀^{[0]}≠0, the first pixel must be set separately from the first run.

We also require the initial value error term \hat{β}₀^{[0]} of order zero normalized against the slope of the line. Given the average run length in the line τ^{[1]}=41/17 in example line 1201,
\hat{β}₀^{[0]}=(y₀=y₀^{[0]})τ^{[1]}=12/17
where y₀−y₀^{[0]} is the distance from the y coordinate of starting point 203 to the y coordinate of the lower left-hand corner 1303 of pixel 1301 and

$${τ}^{[ 1 ]} = \frac{1}{{α}^{1}} .$$

Since X₀^{[0]} is nonzero, the Bitmap Processor sets a run of order 0 (a pixel) into the bitmap memory at the location (x₀^{[0]}, y₀^{[0]})=(0,0). There are two choices for the position of the next pixel in the line segment (1,0) or (1,1). The choice from these two is made using the value of the error term \hat{β}₀^{[0]}. There are two choices for the position of the next pixel in the line segment (x₀^{[0]}+1, y₀^{[0]}) and (x₀^{[0]}+1, y₀^{[0]}+1). The choice from these two is made by the value of the error term \hat{β}₀^{[0]}. Firstly, increment the x coordinate and calculate the next error term of order 0:
x₀^{[0]}=x₀^{[0]}+1
\hat{β}₀^{[0]}=\hat{β}₀^{[0]}+1−X₀^{[0]}
In the example of FIG. 7, this comes out to 12/17+1−1/2=41/34, which is less than τ¹, which equals 41/17.

If the error term is less than the average run length of order 1 as shown at 701 in FIG. 7, the next pixel is pixel (x₀^{[0]}+1, y₀^{[0]}).
if \hat{β}₀^{[0]}<τ^{[1]} then
y₀^{[1]}=y₀^{[0]}

If the error term is greater than or equal to the average run length of order 1 as shown at 709 in FIG. 7, the next pixel is pixel (x₀^{[0]}+1, y₀^{[0]}+1). Accordingly, the error term is also updated.
if \hat{β}₀^{[0]}≧τ^{[1]} then
y₀^{[0]}=y₀^{[0]}+1
\hat{β}₀^{[0]}=\hat{β}₀^{[0]}−τ^{[1]}

If X₀^{[0]} is zero, the values of position of the pixel and the error term are not altered and no pixel is set into the memory.

The position of the next run of order 1 in the line segment and the first error term of order 1 is now the position of the next order 0 run and error term of order 0.
x₀^{[1]}=x₀^{[0]}
y₀^{[1]}=y₀^{[0]}

The coordinate (x₀^{[1]}, y₀^{[1]}) is stored as the position of the next run in the line segment [130].

The error term \hat{β}₀^{[0]} is stored [152] as the error term for the next run [150].

Setting the First Truncated Run of Order i>0

Once the first order has been initialized [504][506], the first truncated run of order 1 through i is set, where i is either the desired maximum order [122] or the maximum order in the hierarchy of runs in the line [124].

The process for setting the first truncated run of order k=1 is as follows. Starting at order k=1 [506]:
1. Calculate the length of the first truncated run of order k [510], r₀^{[k]}.
2. Set the truncated run of order k into the Bitmap Memory [512] if the run is truncated.
3. Check that the end point of the line has not been reached [514]. If it has, cease processing and if it has not continue.
4. Calculate the next error term of order k [516].
5. Check if k is the maximum depth of the hierarchy of runs in the line [520]. If so, set the maximum order of runs [120] to be the maximum order of the hierarchy of runs [124], update and store [152] the final value of the error term [150] [590] and cease processing. If not continue.
6. Check if k is the desired maximum order of runs for the line [530]. If so, update and store [152] the final value of the error term [150] [590] and cease processing. If not continue.
7. The current error term of order k is the next error term for order k+1 [532].
8. Move to the next order [534], k=k+1.
   Structure of the Hierarchy of Runs

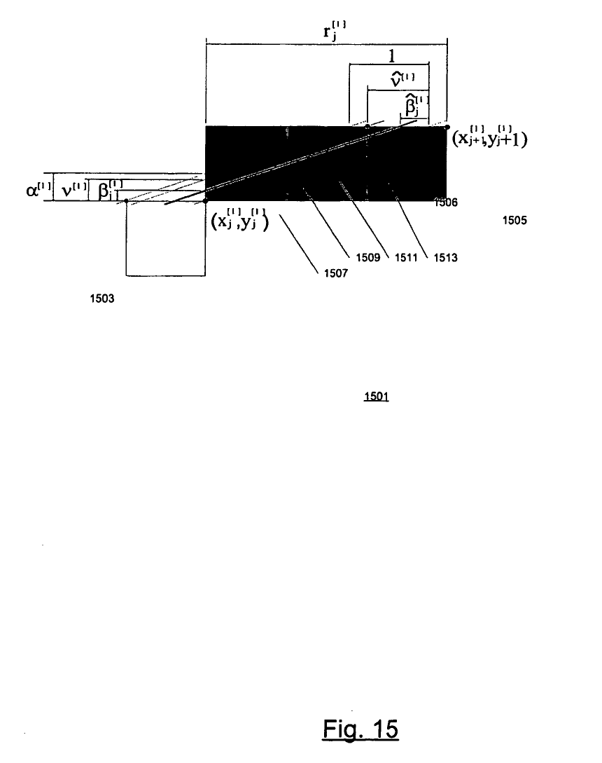

During this process the structure of the hierarchy of runs will be calculated and stored [140]. The structure of the hierarchy of runs stores a description of each level in the hierarchy from order 1 to the defined maximum order [120]. Each record of the description for order i stores the following entries:
The slope of the line of order i, α^{[k]}.
The slope of the line of order 1 is defined to be the slope of the line, α^{[1]}=α.
The slope of the line of order k>1, αk^{[k]}=min(\hat{μ}^{[k-]}, \hat{v}^{[k-1]}).
   The average length of a run of order i in the line, τ^{[k]}=1/α^{[k]}.
   The length of a short run of order i, rₛ^{[k]}=└τ^{[k]}┘.
   The length of a long run of order i, rₗ^{[k]}=|τ^{[k]}|.
   The type of the runs of order i in the line, t^{[k]}, either 0 or 1.
The type of order 1 is defined to be t^{[1]}=0.
The type of order k>1 is defined to be t^{[k]}=0 if \hat{μ}^{[k-1]}≦\hat{v}^{[k-1]}.
The type of order k>1 is defined to be t^{[k]}=1 if \hat{μ}^{[k-1]}>\hat{v}^{[k-1]}).
   The structural parameters \hat{μ}^{[i]} and \hat{v}^{[i]}.
If the type of order k, t^{[k]}=0, then the structural parameters of order k,
   \hat{v}^{[k]}=τ^{[k]}−rₛ^{[k]}, and
   \hat{μ}^{[k]}=1−\hat{v}^{[k]}
If the type of order k, t^{[k]}=1, then the structural parameters of order k,
   \hat{μ}^{[k]}=τ^{[k]}−rₛ^{[k]}, and
   \hat{v}^{[k]}=1−\hat{μ}^{[k]}
   Geometry of the Error Parameter \hat{β}ⱼ^{[1]} and the Structural Parameters \hat{υ}^{[1]} and \hat{μ}^{[1]}: FIG. 15

As may be seen from the foregoing, the error parameter \hat{β}ⱼ^{[i]} is used to calculate lengths of runs and the structural parameters \hat{υ}^{[i]} and \hat{μ}^{[i]} are used to determine the type of an order. FIG. 15 shows geometrically why the error parameter and the structural parameters can be used in this fashion. The figure shows a first-order run j of pixels 1505 representing a portion of line 1507 with slope α. In first-order runs, the slope αl^{[1]} of the run is the same as the slope of the line 1507. Shown at 1503 is the last pixel of the run j−1. The coordinates (xⱼ^{[1]}, yⱼ^{[1]}) are the coordinates of the lower left-hand corner of the first pixel of run j; the coordinates

$$( {x}_{j + 1}^{[ 1 ]} , {y}_{j + 1}^{[ 1 ]} )$$

are the coordinates of the lower left-hand corner of the first pixel of the first pixel of run j+1. The values of the error parameter and the structural parameters are defined geometrically by means of lines that are parallel to line 1507 and intersect corners of the pixels of run j. Thus, line 1509 intersects the upper left-hand corner of pixel 1503; line 1511 intersects the upper left-hand corner of the last pixel 1506 in run j; line 1513 intersects the bottom left-hand corner of the first pixel in run j.

The error parameter \hat{β}ⱼ^{[1]} is the distance on the line formed by the top of pixel 1506 between the intersections of lines 1507 and 1513 with that line. The greater the distance between lines 1507 and 1513, the shorter the next run must be. Moreover, since a line is drawn beginning with a partial run of the maximum order k and the partial run is made by beginning with a partial run of order 1, followed by a partial run of order 2, and continuing through order k, the error term for the partial run of order i is that resulting from order i−1.

The structural parameter \hat{υ}^{[1]} is the distance on the line formed by the top of pixel 1506 between the intersection of line 1513 with the line formed by the top of pixel 1506 and the upper left-hand corner of pixel 1506. The type of order 1 is defined to be 1, so the structural parameter \hat{μ}^{[1]}=1−\hat{υ}^{[1]}. The structural parameters vary with the slope α^{[i]} of the line as represented by runs of order i, and thus can be used to determine the type of order i+1.

Calculation of the Length of the Truncated Run

To calculate the length of the first truncated run of order k [510], r₀^{[k]}, first check if the run is truncated. If the run is not truncated, the length of the first run is assumed to be zero, r₀^{[k]}=0, and no run is set into the Bitmap Memory [512]. The first run of order k in the line is truncated if the stored error term [150], \hat{β}₀^{[k-1]}>1.

If the run of order k is truncated, the length of the run is:
r₀^{[k]}=|τ^{[k-1]}| if the type t^{[k]}=0.
r₀^{[k]}=|\hat{β}₀^{[k-1]}| if the type t^{[k]}=1.

If the run is not truncated, the error term for the next order is the same as this order \hat{β}₀^{[k]}=\hat{β}₀^{[k-1]}. The run of order k and length r₀^{[k]} can now be set into the Bitmap memory.

If the run is truncated the initial truncated run length and initial decision value of order k is:
\hat{β}₀^{[k]}=r₀^{[k]}−τ^{[k]}+\hat{β}^{[k-1]} if the type t^{[k]}=0.
\hat{β}₀^{[k-1]}−r₀^{[k]} if the type t^{[k]}=1.

At the end of the process of setting the initial truncated runs, we have drawn the first truncated run of order i in the line segment. We have the position of the next run of order i in the line if it exists, (x₁^{[i]}, y₁^{[i]}) and the decision value \hat{β}₁^{[1]}. We therefore move to the next phase of the process which calculates the length of the next run of order i in the line, which is then set into the memory. The length of the next run of order i is decided from the two possible by the value of the decision variable, \hat{β}₁^{[i]}.

To update [590] the value of the error term of order i, \hat{β}₁^{[i]}, the value of \hat{β}₁^{[i]} is adjusted by −\hat{v}^{[i]}, \hat{β}₁^{[i]}=\hat{β}₁^{[i]}−\hat{v}^{[i]} and this value is stored [152] for use by the Run Processor [104].

An Example of Setting Orders 1-3: FIG. 14

FIG. 14 shows line 1201 and the pixels 1402 that will be generated to represent it according to the technique under discussion. At 1401 is shown how the first truncated run 1403 of order 1 is set; at 1405 is shown how the first truncated run 1405 of order 2 is set; and at 1407 how the first truncated run of order 3 is set.

Once the first order has been initialized [504][506], the first truncated run of order 1 through i is set, where i is either the desired maximum order [122] or the maximum order in the hierarchy of runs in the line [124]. For the sake of the example, we will take the desired order to be i=3. As part of the initialization, first pixel 1301 has been set and the position of the next pixel relative to first pixel 1301 has been determined as described above.

Order 1

The next step is to handle the first truncated run of order 1 if it exists. In the example line, the portion on the line that will be processed is described by the dark pixels 1403.

The definition of the hierarchy of runs at order 1 in [146] is:
The slope of the line of order 1, α^{[1]}=17/41.
The average length of a run of order 1 in the line, τ^{[1]}=41/17.
The length of a short run of order 1, rₛ^{[1]=└τ}^{[1]}=2.
The length of a long run of order 1, rₗ^{[1]}=|τ^{[1]}|=3.
The type of the runs of order 1 in the line is defined to be, t^{[1]}=0.
The structural parameters \hat{μ}^{[1]} and \hat{v}^{[1]}.
\hat{v}^{[1]}=τ^{[1]}−rₛ^{[1]}=7/17, and
\hat{μ}^{[1]}=1−\hat{v}^{[1]}=10/17.

The length of the first truncated run of order 1 [510], r₀^{[1]}, is truncated since the stored error term [150], \hat{β}₀^{[0]}=41/34>1. The length of the truncated run is r₀^{[1]}=|τ^{[1]}−\hat{β}₀^{[0]}|=┌41/17−41/34┐=2 since the type t^{[1]}=0. The run of order 1 and length r₀^{[1]}=2 can now be set into the Bitmap memory at position (x₀^{[0]}, y₀^{[0]})=(1,0). The initial decision value of order 1 is \hat{β}₀^{[1]}=r₀^{[1]-τ}^{[1]}+\hat{β}₀^{[0]}=2−41/17+41/34=27/34.

Order 2

The initial truncated run of order 2 1405 is described by the dark pixels 1407 in line 1201. The initial truncated run of order 2 has a length of one (i.e. one run of order 1). The position of the initial truncated run of order 2 is (x₀^{[2]}, y₀^{[2]})=(x₀^{[1]}+r₀^{[1]}, y₀^{[2]}+1)=(3,1).

The hierarchy of runs at order 2 is described by the parameters:
a The slope of order 2, α^{[2]}=min(\hat{μ}^{[1]}, \hat{v}^{[1]})=7/17.
The average length of a run of order 2 in the line, τ^{[2]}=17/7.
The length of a short run of order 2, rₛ^{[2]}=2.
The length of a long run of order 2, rₗ^{[2]}=3.
   As \hat{μ}^{[1]}>\hat{v}^{[1]}:
   t^{[2]}=1
   \hat{μ}^{[2]}=τ^{[2]}−rₛ^{[2]}=3/7
   \hat{v}^{[2]}=−\hat{μ}^{[2]}=4/7

The first run of order 2 in the line is truncated because the stored error term [150] renormalized to the slope of order 2, \hat{β}^{[1]}=\hat{β}₀^{[1]}τ^{[2]}=27/14, is greater than 1. Therefore as t^{[2]}=1:
r₀^{[2]}=|\hat{β}₀^{[1]}|=1
\hat{β}₀^{[2]}=\hat{β}₀^{[1]}−r₀^{[2]}=13/14

As the shape of the runs of order 2 is shape ls⁺, the last run of order 1 in a run of order 2 is a short run of order 1. A short run of order 1 has a length of two pixels. Therefore two pixels are set in this stage.

Order 3

The initial truncated run of order 3 1409 is described by the dark pixels 1411. The initial truncated run of order 3 has a length of one (i.e. one run of order 2). The runs of order 3 in the line have a shape s⁺l, the last run of order 2 in a run of order 3 is a long run. Therefore we will set a run of order 2 of length three.

The hierarchy of runs at order 3 is described by the parameters:
The slope of order 3, α^{[3]}=min(\hat{μ}^{[2]}, \hat{v}^{[2]})=3/7.
The average length of a run of order 3 in the line, τ^{[3]}=7/3.
The length of a short run of order 3, rₛ^{[3]}=2.
The length of a long run of order 3, rₗ^{[3]}=3.
   As \hat{μ}^{[2]}<\hat{v}^{[2]}:
   t^{[3]}=0
   \hat{v}^{[3]}=τ^{[3]}−rₛ^{[3]}=2/3
   \hat{μ}^{[3]}=1−\hat{v}^{[3]}=2/3

The first run of order 2 in the line is truncated because the stored error term [150] renormalized to the slope of order 3, \hat{β}₀^{[2]}=\hat{β}₀^{[2]}τ^{[3]}=13/6, is greater than 1. Therefore as t^{[2]}=0:
r₀^{[3]}=|τ^{[3]}−\hat{β}₀^{[2]}|=┌1/6┐=1
\hat{β}₀^{[3]}=r₀^{[3]}−τ^{[2]}=\hat{β}₀^{[2]}=5/6

Therefore, a single run of order 2 comprises the run of order 3. Now that the order chosen for the iterative portion of the technique has been reached, the normalized intercept value of order 3, \hat{β}₀^{[3]}=5/6, can be used to initialize the iterative decision process.

Setting Full-length Runs of Order i in the Line; FIG. 8

To set a full length run of order i into the Bitmap Memory [108], the Run Processor [104] performs the steps shown in flowchart 801. The inputs are the maximum order of the runs (120), the structure of the hierarchy of runs [146] which was determined by truncated run processor [102] while processing the truncated runs, and the error term \hat{β}ⱼ^{[i]} provided by truncated run processor [102]. For each run of order i, the run processor determines the length of the run of order i in the line and passes the run's length and order to the Bitmap Processor [106] to set the actual pixels of the run into the Bitmap Memory [732]. The calculation of the length of the run of order i is based on the type of order (i) [702] and the value of the error term [150], \hat{β}ⱼ^{[i]}, retrieved [158] by the Run Processor [710,720]. Once the length of the run has been calculated, the error term is updated,

$${\hat{β}}_{j + 1}^{[ i ]} ,$$

and stored [156]. The flow chart branches involved here are [702, 710, 712, 714]; [702, 710, 716, 718]; [702, 720, 722, 724]; and [702, 720, 726, 728].

The calculation of the length of the run of order i in the line, rⱼ^{[i]} is as follows:
If type t^{[i]}=0:
If \hat{β}ⱼ^{[i]}≧0 [710] the run is short [712], rⱼ^{[i]}=rₛ^{[i]}, and

$${\hat{β}}_{j + 1}^{[ i ]} = {\hat{β}}_{j}^{[ i ]} - {\hat{v}}^{[ i ]} . \qquad [ 714 ]$$
If \hat{β}ⱼ^{[i]}<0 [710] the run is long [716], rⱼ^{[i]}=rₗ^{[i]}, and

$${\hat{β}}_{j + 1}^{[ i ]} = {\hat{β}}_{j}^{[ i ]} + {\hat{μ}}^{[ i ]} . \qquad [ 718 ]$$

If type t^{[i]}=1:
If \hat{β}ⱼ^{[i]}≧0 [720] the run is long [722], rⱼ^{[i]}=rⱼ^{[i]}, and

$${\hat{β}}_{j + 1}^{[ i ]} = {\hat{β}}_{j}^{[ i ]} - {\hat{v}}^{[ i ]} . \qquad [ 724 ]$$
If \hat{β}ⱼ^{[i]}<0 [720] the run is short [726], rⱼ^{[i]}=rₛ^{[i]}, and

$${\hat{β}}_{j + 1}^{[ i ]} = {\hat{β}}_{j}^{[ i ]} + {\hat{μ}}^{[ i ]} . \qquad [ 728 ]$$

The values of the structural parameters \hat{μ}^{[i]} and \hat{v}^{[i]} and the length of a short and long run, rₛ^{[i]} and rₗ^{[i]}, are retrieved [144] from the structure of the hierarchy of runs [140].

Once the length of the run is calculated, the run is set into memory [194] by the Bitmap Processor [106] and [732]. The Run Processor keeps processing runs as just described until it reaches the end of the line segment [730].

Applications of the Line Drawing Techniques

The line drawing techniques described herein can be employed in any application where techniques of the general class to which these techniques belong are useful. The techniques are of course particularly useful in applications where the coordinates of the endpoints of the lines may have real number values, including values that are irrational numbers. Such applications include the following:

Two-Dimensional Polygon Filling and Scan Conversion

Techniques for filling a polygon on a raster or bitmap display often step along the circumference of the polygon and fill or scan convert the polygon along the horizontal runs defining the interior of the polygon (see Lathrop 1990). A problem with using existing line drawing techniques for this purpose is that the endpoints of the line are defined at pixel or sub-pixels positions and using these algorithms to step along the circumference of the polygon can cause dropouts or multiply processed pixels to occur. The line drawing technique described can be used to step along the circumference of the polygon without these errors.

Three-Dimensional Polygon Scan Conversion

When a 3D polygon is being rendered into a 2D image using interpolative techniques such as Gouraud or Phong shading, typically a technique similar to the 2D polygon scan conversion embodiment is used. A technique that is also possible is to shade the polygon using lines of constant depth. Think of a plane parallel to the view plane being used. As the plane is moved backwards through the polygon, the line of intersection between the plane and the polygon can be defined. This line has a constant depth that can be used to make the shading technique more efficient. To shade the polygon you can step along this line using the line drawing technique described setting each pixel the color calculated by the shading algorithm.

Visibility Checking—Computer Games and Simulation In computer games and simulation a common problem is to determine if two points are visible to one another. If the environment that can occlude the two points can be defined on a 2D grid, the line drawing technique describe can be used to check each of the grid points linearly separating the two points to determine if they are occluded from one another.

Visibility Checking—Mobile Network Planning

In the mobile phone industry, one of the greatest problems is in planning the mobile phone base station network to ensure effective coverage. Mistakes in deciding where to place base stations and their power requirements can be very expensive. One common solution is to use two-dimensional ray tracing methods to simulate the working environment of a mobile network. Effectively the environment is modeled in two dimensions and rays are traced through the environment to determine the coverage achieved. If the space around the environment is modeled as a grid, the process for drawing a line can be used to traverse a ray through the grid. The line segment becomes a ray if no endpoint is assumed. As the line is traced through the environment, instead of drawing each pixel in the display bitmap, the grid cell can be checked.

Simulation of Sonar Propagation

In sonar propagation simulation, often laminar sheets of water or other media are traced with rays to determine the propagation of rays through the medium. If the media can be modeled on a discrete grid, the line drawing algorithm can be used to propagate the ray through the medium.

Height Field Rendering

Ray tracing has long been used to render height fields or elevation maps. The run-based ray line drawing technique can be adapted to traverse a ray over the height field to seek an intersection with an elevation.

Hough Transform

In line and shape detection problems in which the Hough Transform is used as a voting strategy, the voting process requires a line of votes to be cast into an array. The run-based line digitization techniques described can be used to cast the votes.

Additional Line Drawing Techniques that Use the Line Structure Information

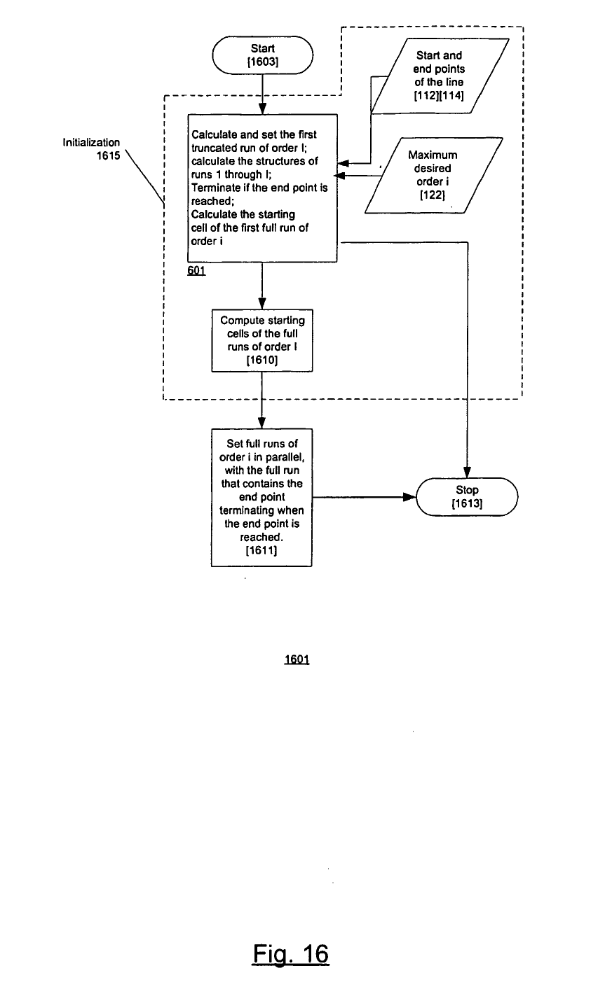

The line drawing techniques that are the subject matter of PCT/US02/24711, the parent of this patent application, require that information about the structure of the line being drawn be computed. The structural information can also be used to enhance other aspects of drawing a line. Three of these are discussed in the following:
techniques for drawing lines or computing rays in parallel;
techniques for adding anti-aliasing pixels to lines drawn using runs of pixels; and
techniques for improving memory setting processes based on runs.
Parallel Techniques for Determining the Cells of a Raster that are Intercepted by a Line: FIG. 16

An advantage of using runs of any order n to determine the cells of a raster that are intercepted by a line is that once the first truncated run of order n is drawn and the structural information about the line has been computed, it can be used to determine the positions in the raster of all of the other runs of order n of cells that are intercepted by the line. Consequently, if the hardware or software being used to determine the cells permits it, the cells belonging to the other runs of order n can be computed in parallel. The parallel computations can be performed by calculating each run of order n in the cells intersected by the line in parallel; or by calculating the positions of groups of runs of order n in the cells intersected by the line in parallel and using the sequential version of the algorithm to draw each group. Another level of parallelism could be attained within each run by setting multiple runs of a lower order or pixels per iteration of the sequential or parallel version of the algorithm. The run of order n could be divided into runs of an order less than n, each of which could be processed in parallel.

FIG. 16 gives an overview of how runs may be computed in parallel. There are two parts: initialization 1615, which calculates and sets the first truncated run of cells and then computes the starting cells of each of the full runs of order i being set, and the part 1615 that sets the full runs in parallel. Beginning with start 1603, the first part of the initialization is done as shown in FIG. 6. As set forth in the explanation of FIG. 6, truncated run processor 102 receives as inputs the endpoints of the line; from the endpoints, it calculates the line's slope and determines the starting pixel and the starting point and error term β for the first run truncated run of order 1. Then it proceeds as follows for that order and all others 1 . . . n: first it calculates the length of the truncated run of the order, then it sets the truncated run in the bitmap, and then it calculates the error term for the next order. At the end of the process, the location of the starting pixel of the first full run of order n is known, along with the error term. From this information, the starting cells and structure parameters of each of the full runs of order n may be computed, as shown at 1610. This completes the initialization, and the full runs are set in parallel, with the last run terminating when the line's end point is reached.

The apparatus of FIG. 2 may be modified to perform the processing of FIG. 16 by replacing bitmap processor [106] with a number of bitmap processors 106 (a . . . j), which can operate on bitmap memory 108 in parallel. Run processor 104 would then give each bitmap processor 106(i) the starting cell and structure parameters for the run that bitmap processor 106(i) is to set. The degree of order n may be determined by the number of bitmap processors 106; for example, if there are four bitmap processors, the degree of order n may be that at which the line contains full runs and a final truncated or untruncated run such that the total number of the full and final runs is divisible by 4. The degree of order n may be determined by the designer or based on external parameters such as the length and slope of the line. The bitmap processors may also be able to set an array of bits in a single operation; in that case, the order whose runs best fit the array that the bitmap processor can set might be the one for which the operation is parallelized.

Computing the Starting Points of the Runs for Order 1

To calculate the position of the j-th full length run in the line, let us reconsider the linear equation given by
βⱼ^{[1]}−β₀^{[1]}=α^{[1]}(xⱼ^{[1]}−x₀^{[1]})−(yⱼ^{[1]}−y₀^{[1]}).
where β₀^{[1]} is the intercept value of the first full length run given at position (x₀^{[1]}, y₀^{[1]}). We know that j=yⱼ^{[1]}−y₀^{[1]} as the height of a run is always one.

Therefore the position of the j-th full length run in the line is
(xⱼ^{[1]}, yⱼ^{[1]})=([βⱼ^{[1]}−β₀^{[1]}+j+x₀^{[1]}]/α^{[1]}, y₀^{[1]}+j)

To increase the efficiency of the algorithm, we can normalize each of the values at order 1 by α^{[1]}. This eliminates a number of division and multiplication operations.

Computing the Starting Points of the Runs for Order 2

To calculate the position of the j-th run in the line, let us reconsider the linear equation given by
βⱼ^{[1]}−β₀^{[1]}=α^{[1](}xⱼ^{[1]}−x₀ⱼ^{[1]})−(yⱼ^{[1]}−y₀^{[1]}).
For order 2 we have
βⱼ^{[2]}−βₒ^{[2]}=α^{[1](}xⱼ^{[2]}−x₀^{[2]})−α^{[0](}yⱼ^{[2]}−y₀^{[2]}).
Define pⱼ^{[h]}, where h≦i, to be the number of runs of order h in the partial line up to the beginning of the j-th run of order i from the first full-length run of order 2. Therefore
pⱼ^{[0]}=xⱼ^{[2]}−x₀^{[2]}
pⱼ^{[1]}=yⱼ^{[2]}−y₀^{[2]}
pⱼ^{[2]}=j
The above linear equation for order 2 becomes
βⱼ^{[2]}=α ^{[1]}pⱼ^{[0]}−α^{[0]}pⱼ^{[1]}.
For runs of order 2, shape 0, we have α^{[2]}=μ^{[1]}=(r^{[1]}+1)α^{[1]}−α^{[0]} and by substituting for α^{[0]} into the previous equation we have
βⱼ^{[2]}=α^{[2]}pⱼ^{[1]}−α^{[1]}((r^{[1]}+1)pⱼ^{[1]}−pⱼ^{[0]})
For this shape, each run of order 2 must contain a long run of order 1 and r^{[1]}+1 short runs therefore α^{[1]}=(r^{[1]}+1)pⱼ^{[1]}−pⱼ^{[0]}, and
βⱼ^{[2]}=α^{[2]}pⱼ^{[1]}−α^{[1]}pⱼ^{[2]}.
Similarly for shape 1 we get
βⱼ^{[2]}=α_{[1]}pⱼ^{[2]}−α^{[2]}pⱼ^{[1]}.
Hence for shape 0

$${y}_{j}^{[ 2 ]} = {y}_{0}^{[ 2 ]} + \frac{j {α}^{[ 1 ]} - {β}_{j}^{[ 2 ]} + {β}_{0}^{[ 2 ]}}{{α}^{[ 2 ]}}$$

$${x}_{j}^{[ 2 ]} = {x}_{0}^{[ 2 ]} + \frac{{y}_{j}^{[ 2 ]} + {β}_{j}^{[ 2 ]} - {β}_{0}^{[ 2 ]}}{{α}^{[ 1 ]}}$$

and for shape 1

$${y}_{j}^{[ 2 ]} = {y}_{0}^{[ 2 ]} + \frac{j {α}^{[ 1 ]} + {β}_{j}^{[ 2 ]} - {β}_{0}^{[ 2 ]}}{{α}^{[ 2 ]}}$$

$${x}_{j}^{[ 2 ]} = {x}_{0}^{[ 2 ]} + \frac{{y}_{j}^{[ 2 ]} + {β}_{j}^{[ 2 ]} - {β}_{0}^{[ 2 ]}}{{α}^{[ 1 ]}}$$

To increase the efficiency of the algorithm, we can normalize each of the values at order 2 by α^{[2]}, as in order 1. This eliminates a number of division and multiplication operations. In this case we can also define \hat{α}^{[2]}=min(\hat{v}^{[2]},\hat{μ}^{[2]}) to be the proportion of runs of order i to order 1 where τ^{[2]=}1/\hat{α}^{[2]} is the average run length of order 2.
Computing the Starting Points of the Runs for Order i

To describe a general algorithm for any order i we can expand the definition of the algorithm for order 2. The main differences between the algorithm of order 2 and i, is that runs of any order i>2 occur in one of the four possible shapes not two. For orders beyond 2 however there is no restriction that the first run in the line y=αx is long, therefore all four shapes are possible. Apart from this key difference, the calculation of the structural parameters, the length of the initial truncated run length, the starting point of each run of order i and the length of each run of order i can be derived from order 2.

To expand on our idea of shape at order 2, we define the type instead of the shape of the runs of order i>1 to be type t^{[i]}=0 if μ^{[i-1]}<v^{[i-1]}, type t^{[i]}=1 if v^{[i-1]}<μ^{[i-1]} and define the type of order 1 to be t^{[i]}=0, we can calculate the shape by the relationship
s^{[i]}=t^{[i-1]}⊕t^{[i]}
where the operator ⊕ denotes the binary concatenation of the two types. For example if t^{[2]}=1 and t^{[3]}=0, shape s^{[3]} has the binary value “10”, or decimal 2, and therefore, s^{[3]}=2: sl⁺. We can use these definitions of type and shape for order 2 by assuming that the type of all runs of order 1 will always be type 0.

The method of calculating the position of the j-th run of order i>2 also follows from our discussion of order 2. To calculate the position of the j-th run in the line, let us reconsider the linear equation given by
β₀^{[1]}−β₀^{[1]}α^{[1]}(xⱼ^{[1]}−x₀ⱼ^{[1]})−(yⱼ^{[1]}−y₀ⱼ^{[1]})
or
βⱼ^{[1]}−β₀^{[1]}=α^{[1]}pⱼ^{[0]}−α^{[0]}pⱼ^{[1]}.

By induction, it is possible to show that for order i, type 0
βⱼ^{[i]}−β₀^{[i]}=α^{[i]}pⱼ^{[i-1]}−α^{[i-1]}pⱼ^{[i]}
and for order i, type 1
   βⱼ^{[i]}−β₀^{[i]}=α^{[i-1]}pⱼ^{[i]}−α^{[i]}pⱼ^{[i-1]}

Therefore, because pⱼ^{[i]}=j, we can substitute back to orders 1 and 0 where pⱼ^{[1]}=yⱼ^{[i]}−y₀^{[i]} and pⱼ^{[0]}=xⱼ^{[i]}−x₀^{[i]} in a similar manner as we performed for order 2.

To increase the efficiency of the algorithm, we can normalize each of the values at order i by α^{[i]}, similarly to what we did for order 2. This eliminates a number of division and multiplication operations. In this case we can also define \hat{α}^{[i]}=min(\hat{v}^{[i]}, μ^{[i]}) to be the proportion of runs of order i to order 1 where τ^{[i]}=1/α^{[i]} is the average run length of order 2.

Implementing the Calculation of the Starting Positions and Compositions of the Full Runs of Order 1

In the following, μ and v are the structural parameters described in the parent of the present application. For each scanline, j, in the image given the line segment (x₀, y₀) to (x₁, y₁) such that └y₀┘≦j≦┌y₁┐ where x₀, y₀, x₁, y₁ ∈ R and x₀<x₁:
1. If └y₀┘≦j≦┌y₁┐, the scan line intersects the line segment.
2. The starting point for the line is:
   x₀^{[0]}=└x₀┘
   y₀^{[0]}=└y₀┘
3. To handle the first pixel, the distance of the intercept to the position of the first pixel is calculated:
   β′=(y₀−└y₀┘)−(x₀−└x₀┘)α^{[1]}
   If β′≧0 then β₀^{[0]}=β′. If β′21 0 then β₀^{[1]}=β′−α^{[1]} and the position of the first run is reset to (x₀^{[0]}, y₀^{[0]})=(└x₀+1, └y₀┘).
4. Calculate the average run length of order 1.

$${τ}^{[ 1 ]} = \frac{{x}_{1} - {x}_{0}}{{y}_{1} - {y}_{0}}$$
5. The length of the initial truncated run is

$${r}_{t}^{[ 1 ]} = ⌈ {τ}^{[ 1 ]} - {\hat{β}}_{0}^{[ 0 ]} ⌉$$
6. The intercept value at the start of the first full-length run of order 1 is:
   \hat{β}₀^{[1]}=rₗ^{[0]}−(τ^{[1]}−\hat{β}β₀^{[0]})
7. If the scanline intersects the start point, i.e. if y₀^{[0]}=j, set a run length r₀^{[1]} at pixel (x₀^{[0]}, y₀^{[0]}) and cease.
8. We now have └y₀┘<j≦┌y₁ ┐. Set the reference point for the line to start of the first full-length run of order 1 in the line
   (x₀^{[1]}, y₀^{[1]})=(x₀^{[0]}+r₀^{[1]}, y₀^{[0]}+1)
9. The length of a short run is
   rₛ^{[1]}=└τ^{[1]}┘
10. The portion of long runs of order 1 to the total number of run of order 1 in the line is
   \hat{v}^{[1]}=τ^{[1]}−rₛ^{[1]}
11. The vertical distance from the reference point to the intercept of the line and the j-th run is
   δ\hat{β}ⱼ^{[1]}=\hat{β}₀^{[1]}+j(1−\hat{v}^{[1]})
12. The normalized intercept value of the line and the j-th run is
   \hat{β}ⱼ^{[1]}=Δ\hat{β}ⱼ^{[1]}−└Δ\hat{β}ⱼ^{[1]}┘
13. The position of the run is
   (xⱼ^{[1]}, y^{[1]})=(\hat{β}ⱼ^{[1]}+jτ^{[1]}, j)
14. If the scanline intersects the end point of the line segment, i.e. if y₀^{[1]}=y₁, calculate the last truncated run length
   rⱼ^{[1]}=y₀^{[1]}−┌y₁┐
   Set a run of length rⱼ^{[1]} at pixel (xⱼ^{[1]}, yⱼ^{[1]}) and cease.
15. We now have └y₀┘<j<┌y₁┐ and only the intermediate runs remain. The length of the j-th run is
   rⱼ^{[1]}=rₛ^{[1]} if \hat{β}^{[1]}≧\hat{v}^{[1]}
   rⱼ^{[1]}=rₛ^{[1]}+1 if \hat{γ}ⱼ^{[1]}<\hat{v}^{[1]}
   Set a run of length rⱼ^{[1]} at pixel (x₁^{[1]}, yⱼ^{[1]})
   Implementing the Calculation of the Starting Positions and Compositions of the Full Runs of Order 2

We assume that the steps 1-5 and 7-10 have been executed and we have values for the parameters x₀^{[0]}, y₀^{[0]}, x₀^{[1]}, y₀^{[1]}, rₜ^{[1]}, rₛ^{[1]}, \hat{β}₀^{[1]}, \hat{v}^{[1]}, τ^{[1]}. If j=0 and the first possibly truncated run in the line is to be set, we assume that the first possibly truncated run of order 1 has been set.
1. Calculate the shape of the run of order 1.
   If 1−\hat{v}^{[1]}<\hat{v}^{[1]}
   s^{[2]}=0
   else
   s^{[2]}=1
2. Calculate the average run length of order 1.
   If s^{[2]}=0
   τ^{[2]}=1/(1−\hat{v}^{[1]})
   else
   τ^{[2]}=1/\hat{v}^{[1]}
3. The length of the initial truncated run is
   If s^{[2]}=0
   rₜ^{[2]}=|τ^{[2]}−\hat{β}₀^{[1]}|
   else
   rₜ^{[2]}=└\hat{β}₀^{[1]}┘
4. The intercept value at the start of the first full-length run of order 1 is:
   If s^{[2]}=0
   \hat{β}₀^{[2]}=rₜ^{[2]}−(τ^{[2]}−\hat{β}₀^{[1]})
   else
   \hat{β}₀^{[2]}=\hat{β}₀^{[1]}−rₜ^{[2]}
5. If j=0, set a run of order 1 and length r₀^{[1]} at pixel (x₀^{[0]}, y₀^{[0]}). Then set a run of order 2, length r₀^{[2]} and shape s^{[2]} at pixel (x₀^{[1]}, y₀^{[1]}) and cease.
6. Set the reference point for the line to start of the first full-length run of order 2 in the line:
   If s^{[2]}=0
   (x₀^{[2]}, y₀^{[2]})=(x₀^{[1]}+r₀^{[2]}(rₛ^{[1]}+1)−1, y₀^{[1]}+r₀^{[2]})
   else
   (x₀^{[2]}, y₀^{[2]})=(x₀^{[1]}−r₀^{[2]}rₛ^{[1]}−1, y₀^{[1]}−r₀^{[2]})
7. The length of a short run is
   rₛ^{[2]}=└τ^{[2]}┘
8. The portion of long runs of order 1 to the total number of run of order 1 in the line is
   If s^{[2]}=0
   \hat{v}^{[2]}=τ^{[2]}−rₛ^{[2]}
   else
   \hat{v}^{[2]}=1−(τ^{[2]}−rₛ^{[2]})
9. The run-based distance from the reference point to the intercept of the line and the j-th run is:
   δ\hat{β}ⱼ^{[2]}=\hat{β}₀^{[2]}−j(1−\hat{v}^{[2]})
10. The normalized intercept value of the line and the j-th run is
   \hat{β}ⱼ^{[2]}=Δ\hat{β}ⱼ^{[2]}−└Δ\hat{β}ⱼ^{[2]}┘
11. The position of the run is
   If s^{[2]}=0
   yⱼ^{[2]}=y₀^{[2]}+jτ^{[2]}+\hat{β}ⱼ^{[2]}−\hat{β}₀^{[2]}
   xⱼ^{[2]}=x₀^{[2]}+yⱼ^{[2]}τ^{[1]}+(\hat{β}ⱼ^{[2]}−\hat{β}₀^{[2]})/τ^{[2]}
   else
   yⱼ^{[2]}=y₀^{[2]}+jτ^{[2]}\hat{β}ⱼ^{[2]}+\hat{β}₀^{[2]}
   xⱼ^{[2]}=x₀^{[2]}+yⱼ^{[2]}τ^{[1]}−(\hat{β}ⱼ^{[2]}−\hat{β}₀^{[2]})/τ^{[2]}
12. The length of the j-th run is
   rⱼ^{[2]}=rₛ² if \hat{β}ⱼ^{[2]}≧\hat{v}^{[2]}
   rⱼ^{[2]}=rₛ^{[2]}+1 if \hat{β}ⱼ^{[2]}<\hat{v}^{[2]}
13. Set a run of length rⱼ^{[2]} shape s^{[2]}=t^{[2]} at pixel (xⱼ^{[2]}, yⱼ^{[2]})
   Implementing the Calculation of the Starting Positions and Compositions of the Full Runs of Order i

We assume we have values for the parameters x₀^{[k]}, y₀^{[k]}, rₜ^{[k]}, rₛ^{[k]}, \hat{β}₀^{[k]}, \hat{v}^{[k]}, τ^{[k]}, where k=0 . . . i−1. If j=0 and the first possibly truncated run of order i in the line is to be set, we assume that the first possibly truncated run of order i−1 has been set.
1. Calculate the shape of the run of order 1.
If 1−\hat{v}^{[i-1]}<\hat{v}^{[i-1]}
t^{[i]}=0
else
t^{[i]}=1
2. Calculate the average run length of order 1.
If t^{[i]}=0
τ^{[i]}=1/(1−\hat{v}^{[i-1]})
else
τ^{[i]}=1/\hat{v}^{[i-1]}
3. The length of the initial truncated run is
If t^{[i]}=0
rₜ^{[i]}=|τ^{[i]}−\hat{β}₀^{[i-[1]}|
else
   rₜ^{[i]}=└β₀^{[i-1]}┘
4. The intercept value at the start of the first full-length run of order 1 is:
If t^{[i]}=0
   \hat{β}₀^{[i]}=rₜ^{[i]}−(τ^{[i]}−\hat{β}₀^{[i-1]})
else
   \hat{β}₀^{[i]}=\hat{β}₀^{[i-1]}−rₜ^{[i]}
5. If j=0, set a run of order i and length r₀^{[i]} at pixel (x₀^{[i-1]}, y₀^{[i-1]}).
6. Set the reference point for the line to start of the first full-length run of order 2 in the line:
   δr^{[k]}=r₀^{[i]}
for k=−1, . . . , 1
   if t^{[i]}=0
   δr^{[k]}=δr^{[k+1]}(rₛ^{[k]}+1)−1
   else
   δr^{[k]}=δr^{[k]}rₛ^{[k-1]}−1
   y₀^{[1]}=y₀^{[1]}+δr^{[1]}
   x₀^{[i]}=x₀^{[1]}+δr^{[0]}
7. The length of a short run is
   rₛ^{[i]}=└τ^{[i]}┘
8. The portion of long runs of order 1 to the total number of run of order 1 in the line is
   If t^{[i]}=0
   \hat{v}^{[i]}=τ^{[i]}−rₛ^{[i]}
   else
   \hat{v}^{[i]}=1−(τ^{[i]}−rₛ^{[i]})
9. The run-based distance from the reference point to the intercept of the line and the j-th run is:
   δ\hat{β}ⱼ^{[i]}=\hat{β}₀^{[i]}+j(1−\hat{v}^{[i]})
10. The normalized intercept value of the line and the j-th run is
   \hat{β}ⱼ^{[i]}=Δ\hat{β}ⱼ^{[i]}−└Δ\hat{β}ⱼ^{[i]}┘
11. The position of the run is
   pⱼ^{[1]}=j
   for k=i, . . . , 1
   if t^{[i]}=0
   pⱼ^{[k-1]}=τ^{[2]}pⱼ^{[k]}+(βⱼ^{[2]}−β₀^{[2]})
   else
   pⱼ^{[k-1]}=τ^{[2]}pⱼ^{[k]}+(βⱼ^{[2]}−β₀^{[2]})
   else
   pⱼ^{[k-1]}=τ^{[2]}pⱼ^{[k]}−(βⱼ^{[2]}−β₀^{[2]})
   yⱼ^{[i]}=y₀^{[i]}−pⱼ^{[1]}
   xⱼ^{[i]}=x₀^{[i]}−pⱼ^{[0]}
12. The length of the j-th run is
   rⱼ^{[i]}=rₛ^{[i]} if \hat{β}ⱼ^{[i]}≧\hat{v}^{[i]}
   rⱼ^{[i]}=rₛ^{[i]}+1 if \hat{β}ⱼ^{[i]}<\hat{v}^{[i]}
13. Set a run of length rⱼ^{[i]}, shape s^{[i]}=t^{[1-]}⊕t^{[i]} at pixel (xⱼ^{[i]}, yⱼ^{[i]}).
   Optimizations

For the parallel algorithm, we can rearrange the calculations to move many of the expensive operations into the initialization phase of the algorithm. For example Algorithm 1 illustrates a possible implementation of an order 1 algorithm.

Algorithm 1 Calculating the Length and Position of the j-th Run of Order 1 in the Digital Line.

Constants pertaining to the line:

$${τ}^{[ 1 ]} = \frac{1}{{α}^{[ 1 ]}}$$

$${c}_{0}^{[ 1 ]} = {τ}^{[ 1 ]} {α}^{[ 0 ]}$$

$${c}_{1}^{[ 1 ]} = {τ}^{[ 1 ]} {β}_{0}^{[ 1 ]}$$

$${c}_{2}^{[ 1 ]} = {τ}^{[ 1 ]} {v}^{[ 1 ]}$$

Constants pertaining to the j-th run of order 1.

$${c}_{3}^{[ 1 ]} = \frac{j}{{α}^{[ 1 ]}} = j {c}_{0}^{[ 1 ]}$$

$${c}_{4}^{[ 1 ]} = \frac{{β}_{0}^{[ 1 ]} + j {μ}^{[ 1 ]}}{{α}^{[ 1 ]}} = {c}_{1}^{[ 1 ]} + {c}_{3}^{[ 1 ]} {μ}^{[ 1 ]}$$

$${c}_{5}^{[ 1 ]} = \frac{{β}_{j}^{[ 1 ]}}{{α}^{[ 1 ]}} = {c}_{4}^{[ 1 ]} - ⌊ {c}_{4}^{[ 1 ]} ⌋$$

The position of the j-th run of order 1:
xⱼ^{[1]}=x₀^{[1]}+c₅^{[1]}+c₃^{[1]}−c₁^{[1]}
yⱼ^{[1]}=y₀^{[1]}+j

The length of the j-th run of order 1:
if c₅^{[1]}<C₂^{[1]}
The length of the j-th run of order 1 is long, rⱼ^{[1]}=|τ^{[1]}|.
   else
The length of the j-th run of order 1 is short, rⱼ^{[1]}=└τ^{[1]}┘.

From Algorithm 1, the constants c₁^{[1]} and c₂^{[1]} can be calculated once in the initialization of the algorithm. The constants c₃^{[1]} and c₄^{[1]} can be calculated iteratively as each new parallel task is created from preexisting constants. Therefore each run can be set in parallel for a cost of approximately 6 additions, a multiplication and a comparison compared to a cost of 3 additions and two comparisons for the central loop of the sequential algorithm. Hence, the overhead imposed by the parallelization of the algorithm is quickly recouped.

Similarly, for an order 2 implementation as described in Algorithm 1, migrating to a parallel implementation would add two divisions and a multiplication to the cost of initializing the algorithm and 10 additions, a multiplication and division and a comparison to the cost of calculating the length and position of each run of order 2.

Algorithm 2 Calculating the Length and Position of the j-Th Run of Order 2 in the Digital Line.

Constants pertaining to the line:

$${c}_{0}^{[ 2 ]} = \frac{{α}^{[ 1 ]}}{{α}^{[ 2 ]}}$$

$${c}_{1}^{[ 2 ]} = \frac{{β}_{0}^{[ 2 ]}}{{α}^{[ 2 ]}}$$

$${c}_{2}^{[ 2 ]} = \frac{{v}^{[ 2 ]}}{{α}^{[ 2 ]}}$$

Constants pertaining to the j-th run of order 1:

$${c}_{3}^{[ 2 ]} = j \frac{{α}^{[ 1 ]}}{{α}^{[ 2 ]}} = j * {c}_{0}^{[ 2 ]}$$

$${c}_{4}^{[ 2 ]} = \frac{{β}_{0}^{[ 2 ]} + j {μ}^{[ 2 ]}}{{α}^{[ 2 ]}} = {c}_{1}^{[ 2 ]} + {c}_{3}^{[ 2 ]} {μ}^{[ 2 ]}$$

$${c}_{5}^{[ 2 ]} = \frac{{β}_{j}^{[ 2 ]}}{{α}^{[ 2 ]}} = {c}_{4}^{[ 2 ]} - ⌊ {c}_{4}^{[ 2 ]} ⌋$$

if μ^{[1]}<v^{[1]}
The length of the j-th run of order 2, shape 0: l⁺s:
if c₅^{[2]}<c₂^{[2]}
   The length of the j-th run of order 2 is long, rⱼ^{[2]}=|τ^{[2]}|.
else
   The length of the j-th run of order 2 is short, rⱼ^{[2]}=└τ^{[2]}|.
      The height of the j full runs of order 2, shape 0: l⁺s:
      y=c₅^{[2]}+c₃^{[2]}−c₁^{[2]}
      else
The length of the j-th run of order 2, shape 1: ls⁺:
if c₅^{[2]}<c₂^{[2]}
   The length of the j-th run of order 2 is short, rⱼ^{[2]}=└τ^{[2]}┘.
else
   The length of the j-th run of order 2 is long, rⱼ^{[2]}=|τ^{[2]}|.
The height of the j full runs of order 2, shape 1: ls⁺:
y=c₅^{[2]}−c₃^{[2]}+c₁^{[2]}
The position of the j-th run of order 2 (xⱼ^{[2]}, yⱼ^{[2]})

$${x}_{j}^{[ 2 ]} = {x}_{0}^{[ 2 ]} + \frac{y + {β}_{j}^{[ 2 ]} - {β}_{0}^{[ 2 ]}}{{α}^{[ 1 ]}}$$

$${y}_{j}^{[ 2 ]} = {y}_{0}^{[ 2 ]} + y$$

Algorithm 3 Calculating the Length and Position of The j-th Run of Order i in the Digital line.

Constants pertaining to the line:

$${c}_{0}^{[ i ]} = \frac{{α}^{[ i - 1 ]}}{{α}^{[ i ]}}$$

$${c}_{1}^{[ i ]} = \frac{{β}_{0}^{[ i ]}}{{α}^{[ i ]}}$$

$${c}_{2}^{[ i ]} = \frac{v [ i ]}{{α}^{[ i ]}}$$

Constants pertaining to the j-th run of order i:

$${c}_{3}^{[ i ]} = \frac{j}{{α}^{[ i ]}} = j {c}_{0}^{[ i ]}$$

$${c}_{4}^{[ i ]} = \frac{{β}_{0}^{[ i ]} + j {μ}^{[ i ]}}{{α}^{[ i ]}} = {c}_{1}^{[ i ]} + {c}_{3}^{[ i ]} {μ}^{[ i ]}$$

$${c}_{5}^{[ i ]} = \frac{{β}_{j}^{[ i ]}}{{α}^{[ i ]}} = {c}_{4}^{[ i ]} - ⌊ {c}_{4}^{[ i ]} ⌋$$

The shape of the run of order i:
if μ^{[i-1]}<v^{[i-1]}
t^{[i]}=1
else
t^{[i]}=1

The shape of the run of order i:
s^{[i]}=t^{[i-1]}⊕t^{[i]}

The length of the j-th run of order i:
if t^{[i]}=0
if c₅^{[i]}<c₂^{[i]}
The length of the j-th run of order i is long, rⱼ^{[i]}=|τ^{[i]}|.
else
   The length of the j-th run of order i is short, rⱼ^{[i]}=└τ^{[i]}┘.
      else
if c₅^{[i]}<c₂^{[i]}
   The length of the j-th run of order i is short, rⱼ^{[i]}=└τ^{[i]}┘.
else
   The length of the j-th run of order i is long, rⱼ^{[i]}=|τ^{[i]}|.

The start point of the j-th run of order i:
pⱼ^{[i]}=j
for k=i−1 to 1
if t^{[k]}=0
pⱼ^{[k-1]}=α^{[k-1]}pⱼ^{[k]}/α^{[k]}+(βⱼ^{[k]}−β^{[k]})/α^{[k]}=c₀^{[k]}pⱼ^{[k]}+c₅^{[k]}−c₁^{[k]}
else
pⱼ^{[k-1]}=α^{[k-1]}pⱼ^{[k]}/α^{[k]}−(βⱼ^{[k]}−β₀^{[k]})/α^{[k]}=c₀^{[k]}pⱼ^{[k]}−c₅^{[k]}+c₁^{[k]}
(xⱼ^{[i]}, yⱼ^{[i]})=(pⱼ^{[0]}+x₀^{[i]}, pⱼ^{[1]}−y₀^{[i]})
Efficiency of Parallelization

To compare the efficiency of the parallel and sequential versions of the algorithms, we carry out an asymptotic analysis of the time complexity of the overall hierarchy algorithm for runs to all orders. At the outset we point out that we assume a rational slope α=a/d . We assume a and d are positive integers with a<d. For the case of an algebraic irrational slope α as described in the parent of the present application, a discussion of computing primitives would be required. However, given such a discussion, most of the rational slope analysis can be carried over to the algebraic irrational case. This follows because all of the operations involved in the algorithm are rational and it is well known that equations and inequalities in algebraic irrational numbers involving explicitly rational (in fact algebraic) operations can be decided.

It has been shown in P. D. Stephenson and B. Litow, “Why step when you can run: Iterative line digitization algorithms based on hierarchies of runs”, IEEE Computer Graphics and Applications, 20(6):76-84, November/December 2000) that the number of orders in the hierarchy of runs for a line with slope α is bounded above by O(log d) and that the number of runs in successive orders diminishes very much like partial quotients in the GCD algorithm for a and d. We will make use of this important observation in our analysis.

Initializations across orders are sequential, i.e., values for order i depend on values for order i−1. It is evident that at each order, initialization costs O(1) rational arithmetic operations. We emphasize that the division occurs only within the scope of the floor function. This suggests that the precision needed for division can be reduced considerably below the obvious requirement.

Within each order the computation of run lengths is actually an initialization and we count it as such. The run positions can be computed in parallel. Each position costs O(1) rational arithmetic operations. However, here division appears to require full precision. Assembling our accounting, we have that initialization over all orders costs O(log d) rational arithmetic operations. Idealizing slightly the partial quotients behavior of GCD, we credit order i with d/2ⁱ runs. If we allocate d/2ⁱ processors to the i-th run, the time to compute run positions across all orders is O(1) rational arithmetic operations. This gives a work (time×processors) value of O(d)·(1+1/2+ . . . +1/2^{h}), where h is the maximum order, h≦log d. This yields a work value of O(d). If we allocate fewer processors, the parallel time increases, but it should be possible to choose configurations that preserve the O(d) work value.

In computer graphics and even computational geometry applications of the algorithm, the value of d will probably remain below, say, 10⁴. The boundary condition here is the realization of the digitized line. In graphics the constraint that d<10⁴ seems realistic, since we would be resolving beyond 10⁸ pixels were d to exceed 10⁴. For computational geometry applications, more thought about implicit representations of digitized objects is needed. Using hierarchical run-based methods has shown a significant improvement in the cost to digitize a line. An important reason for the improvement has been the structural information of the digital line provided by its run-based description.

To implement a system based on one of the algorithms presented, the order of the algorithm must be decided either by the designer or dynamically by the system itself. While the length of the runs in the digital line increases exponentially with the order of the run, the cost of initializing an algorithm also rises, albeit linearly. Given that the cost of an iteration to decide the position and length of the next run in the line is so small, the number of runs in the line must be significant enough to warrant using a higher order algorithm.

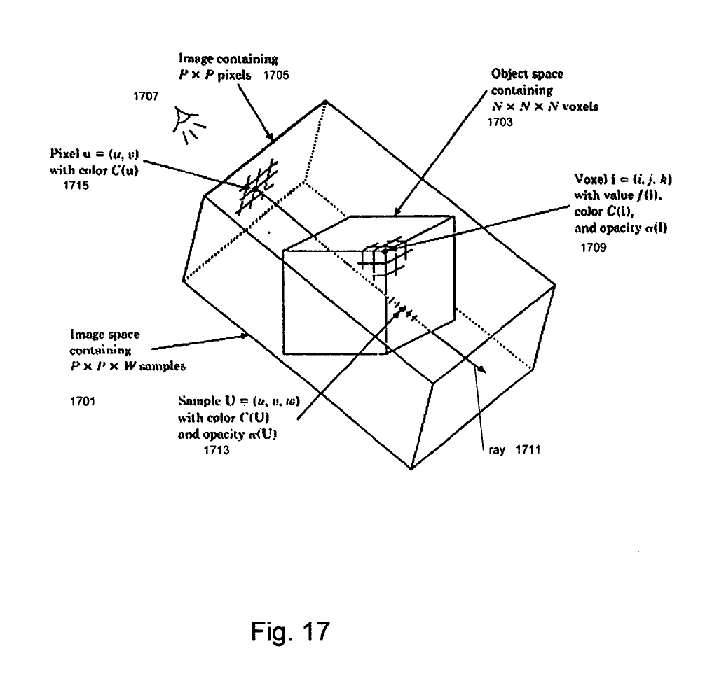

Problems of Ray Traversal in Three Dimensions: FIG. 17

There are many situations where a program needs to compute the traversal of a ray through three-dimensional space. One example of such a program is one that produces a two-dimensional display of a three-dimensional object; another is one that determines how a signal is propagated through a volume. In both cases, there are two problems: representing the traversal in the program and accelerating the traversal through those parts of the three-dimensional space that do not affect the ray. A good general discussion of ray traversal in three dimensions can be found in Marc Levoy. Efficient ray tracing of volume data. ACM Transactions on Graphics, 9(3): 245-261, July 1990. FIG. 17, which shows how ray traversal may be used to make a two-dimensional representation of a three-dimensional object, is a slightly modified version of Levoy's FIG. 2.

The two-dimensional representation of the three-dimensional object is an image 1705 that contains P×P pixels. The image is effectively a “window” into an image space 1701 that contains P×P×W voxels. A voxel is the three-dimensional equivalent of a pixel: it is a data item that corresponds to a cell located at a point (x,y,z) in image space. The data in the voxel contains information about the cell; an example of such information is the color and opacity of the cell. If the color and opacity correspond to data values, the data in the voxel may also include the data values. If image space 1701 is non-empty, it will include one or more object spaces 1703. Each object space has as many voxels as are required to contain all of the voxels for a particular object in image space 1701. Each voxel 1709 in object space 1703 contains data as required for the portion of the object represented by the voxel. It should be noted that, as shown in FIG. 2, object space 1703 may not have the same x, y, and z-axes as image space 1701, and that consequently, a ray 1711 may pass through object space 1703 at any angle relative to the axes of object space 1703.

To make image 1705, one or more rays 1711 corresponding to one or more pixels 1715 in the image are traced through image space 1701. If ray 1711 passes through a voxel 1709 whose data affects the appearance of that pixel, the relevant information from the voxel becomes part of sample 1713 for the pixel. When ray 1711 has completely traversed image space 1701, the information in sample 1713 is used to determine the appearance of pixel 1715.

As can be seen from FIG. 17, an image space 1701 of any size has an enormous number of voxels, and most of the voxels traversed by a particular ray 1711 are either not part of an object space 1703, and therefore provide no information to the traversing ray, or are behind an opaque voxel and can provide no information to the traversing ray beyond what was obtained from the opaque voxel. Efficient traversal of image space 1701 by a particular ray thus requires both efficient techniques for computing the voxels that are intersected by the ray and efficient techniques for determining which of the voxels intersected by the ray contain information that is relevant to the pixel that corresponds to the ray. As will be explained in detail in the following, the run-based techniques described in the parents of the present patent application may be employed both to provide efficient computation of the voxels that are intersected by a ray and to provide efficient determination of which of the voxels intersected by the ray contain information relevant to the ray's pixel. The same techniques can of course be employed in other applications where the information gathered By the ray traversal has uses other than or in addition to display generation.

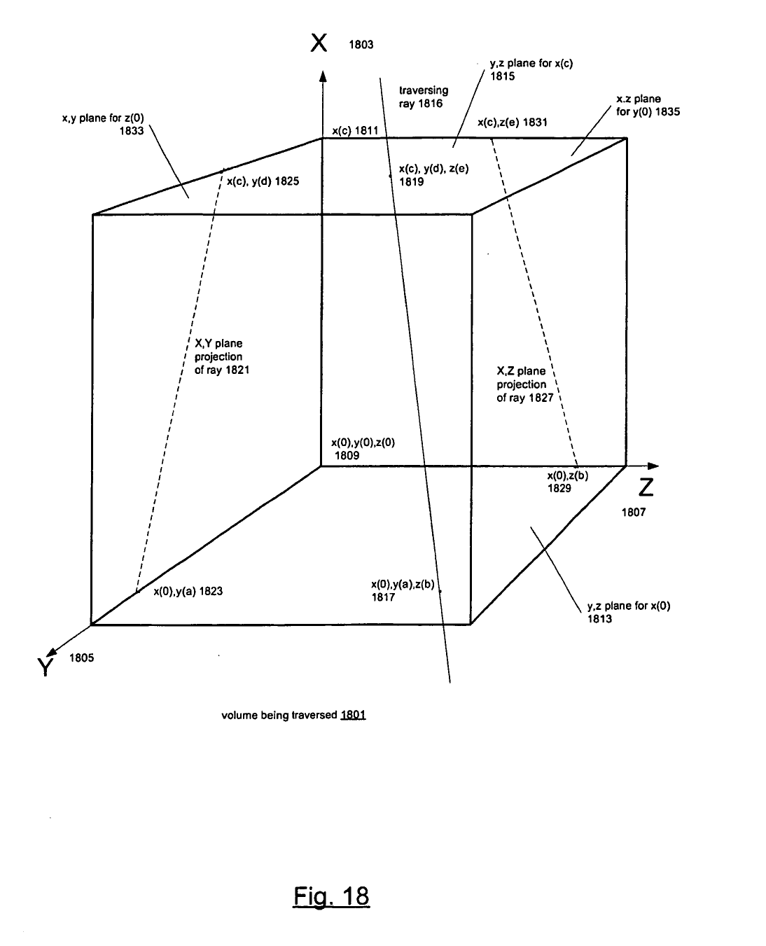

Using Run-Based Techniques to Compute Voxels Intersected by a Ray: FIGS. 18-22

Geometry of Ray Projection: FIG. 18

The techniques that are explained in detail in the following are based on the fact that a ray which is traversing a volume in which positions of points are defined relative to X, Y, and Z axes may be represented as two projections: one on the plane defined by the X and Y axes and another on the plane defined by the X and Z axes. This is shown in the diagram of FIG. 18.

FIG. 18 shows a volume 1801 that is being traversed by a ray 1816. Points in volume 1801 are specified by the triplet (x,y,z), where x is a value on X axis 1803, y is a value on Y axis 1805, and z is a value on Z axis 1807. X axis 1803 is termed the major axis with regard to traversing ray 1816 because the direction of traversing ray 1816 is closer to that of the X axis 1803 than it is to the other two axes. Expressed mathematically, X axis 1803 is the major axis because for any two points on ray 1816, (a,b,c) and (i,j,k), the difference δ between a and i will be greater than the difference δ between b and j or c and k.

Traversing ray 1816 passes through the top and bottom of volume 1801. The top is defined by the y,z plane 1815 made up of all of the points (x,y,z) where x=x(c). The bottom is defined by the y,z plane 1813 of points (x,y,z) where x=x(0). The point at which ray 1816 intersects plane 1815 is point (x(c), y(d), z(e)) 1819; the point at which the ray intersects plane 1813 is (x(0),y(a), z(b)) 1878. Two other planes of interest are x,y plane 1833 made up of all points for which z=z(0) and x,z plane 1835 made up of all points for which y=y(0). These planes are perpendicular to top plane 1815 and bottom plane 1813 and intersect at X axis 1803. As shown in FIG. 18, ray 1816 may be projected onto planes 1833 and 1835. One way of doing the projection onto plane 1833 is to construct a line on top plane 1815 which passes through point 1819 and is perpendicular to the edge of plane 1833 which intersects plane 1815, construct a line on bottom plane 1813 which passes through point 1817 and is perpendicular to the edge of plane 1933 which intersects plane 1813, and then construct the projection 1821 of the ray on plane 1833 by connecting the points at which the perpendicular lines intersect the edges. Projection 1827 on plane 1835 can be constructed in the same fashion.

Between them, projections 1821 and 1827 contain all of the information needed to determine the (x,y,z) coordinates of all of the points in volume 1801 that are on ray 1816; consequently, projections 1821 and 1827 together may be used to represent ray 1819. In the same fashion, a three-dimensional lattice of voxels in volume 1801 may be represented by two-dimensional lattices in planes 1833 and 1835 and the voxels intersected by ray 1816 may be determined from the lattice cells intersected in plane 1833 by projection 1821 and the lattice cells intersected in plane 1835 by projection 1827.

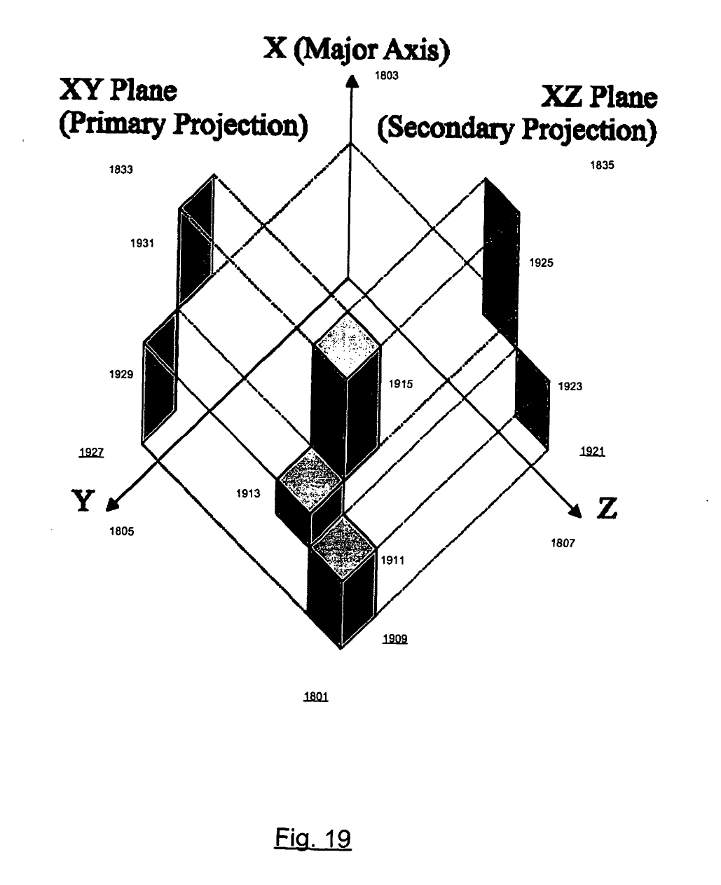

Using Run-Based Techniques to Compute Voxels that are Intersected by a Ray: FIGS. 19-22

Determining cells in a two-dimensional lattice that are intersected by a line is of course the problem addressed by the techniques described in the portion of the present patent application that are carried over from the present application's parents. As set forth there, given two points within a two-dimensional lattice, it is possible to describe lattice cells that are intersected by a line connecting the two points in terms of runs and runs of runs of cells. If the lattices are projection planes such as planes 1833 and 1835 and the lines are projections of a ray on the projection planes, then it is further possible to determine voxels intersected by the ray from the lattice cells intersected by the projection lines.

How voxels intersected by the ray are determined depends upon whether the intersected voxels may be related to each other as 26-connected voxels or must be related to each other as 6-connected voxels. Six-connected voxels must connected to each other face-to-face; since a given voxel has six faces, and it may be connected face-to-face with at most six other voxels; hence the term “six-connected”. 26-connected voxels may also be connected to each other by any of their 8 corners and 12 edges, hence the term “26-connected”. For volume rendering, the minimal 26-connected path of a ray suffices for many applications. In comparison, iso-surfacing volumetric data and ray tracing require the 6-connected ray path. In ray tracing, including edge and corner intersections can also be beneficial to avoid possibly expensive ray-object intersection tests.

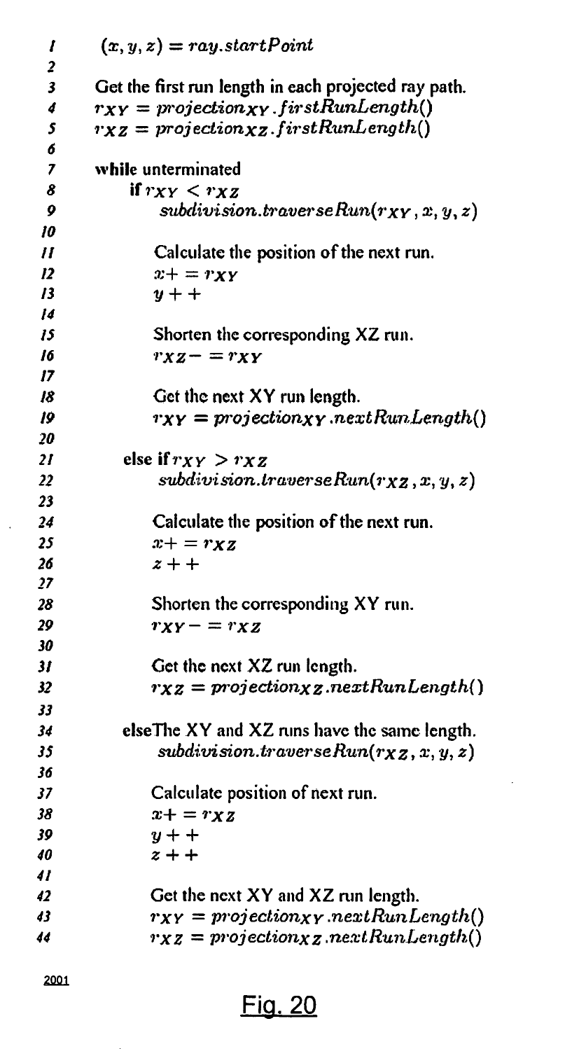

Determining 26-Connected Voxels Intersected by a Ray: FIGS. 19 and 20

FIG. 19 shows how to determine 26-connected voxels intersected by a ray from runs of lattice cells on the XY plane 1833 and the XZ plane 1835 that are intersected by the projections of the ray on the XY and XZ planes. Volume 1801 in FIG. 19 has an X-axis 1803, a Y-axis 1805, and a Z-axis 1807, with the X-axis being the major axis. Projections of the ray have been made on XY plane 1833 and on XZ plane 1835, and the techniques described above have been used to determine lattice cells 1927 intercepted by the projection on the XY plane and lattice cells 1921 intercepted by the projection on the XZ plane. Lattice cells 1921 and 1923 are then used to determine voxels 1909 intersected by the ray.

Determining the runs in the XY plane and the XZ plane is done iteratively or in parallel a run at a time with the corresponding runs of each traversal determining the length of the resultant run of voxels. Starting at the point where the ray intersects bottom plane 1813, the initial runs of lattice cells intercepted by the projections onto the XY and XZ planes are calculated. The shorter of these two runs and the equivalent number of cells of the longer run map to the first run of voxels intercepted by the ray. Thus, in FIG. 19, run of lattice cells 1923 and the corresponding portion of run 1929 map onto run of voxel cells 1911. The remaining portion of the longer run 1929 and a corresponding portion of run 1925 map onto run of voxel cells 1913. The remaining portion of run 1925 and all of run 1931 are then mapped onto run of voxel cells 1915. Voxels intersected by the three-dimensional line can therefore be determined by taking the length of the shorter of the two corresponding runs of cells as the length of the three-dimensional run of voxels. The longer two-dimensional run of cells is then reduced by the length of the shorter run, which is replaced by the next two-dimensional run in its traversal. The procedure is more precisely described in Algorithm 2001 in FIG. 20. The cells in the two-dimensional runs need only be 8-connected, i.e., by any of their four sides or four corners.

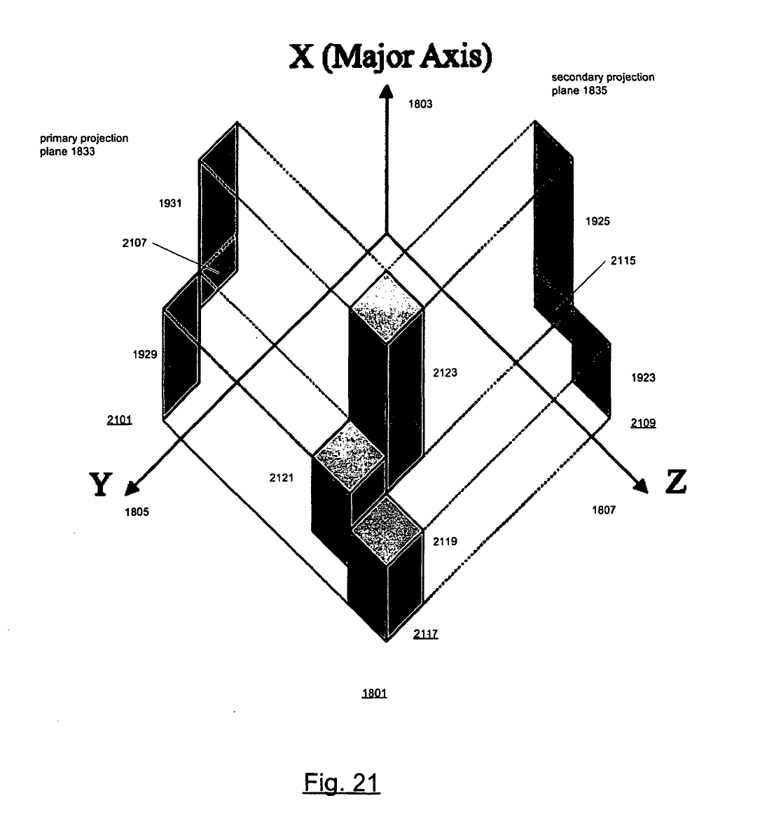

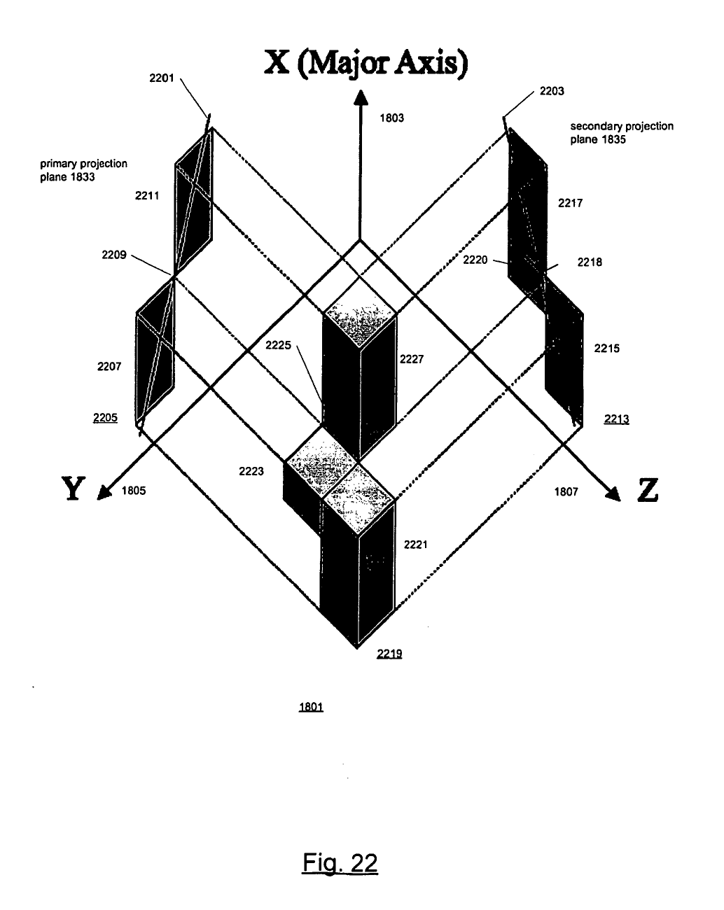

Determining the 6-Connected Voxels Intersected by a Ray: FIG. 21

To construct the 6-connected path of the ray from the ray's projections on primary and secondary projection planes 1833 and 1835, all that is needed is to include an extra cell at the beginning of each two-dimensional run. This process is described in FIG. 21. The runs 1919 and 1931 in plane 1833 and the runs 1923 and 1925 are calculated as described for FIG. 19; however, in set of runs 2101, a cell 2107 is added at the corner where run 1929 and 1931 meet, and the same is done in set of runs 2109.

The 6-connected set of voxels that the ray intersects is shown at 2117. Run 2119 corresponds to run 1923 and the corresponding portion of run 1929; run 2121 corresponds to the remaining portion of run 1929, added cell 2115, and the part of run 1925 corresponding to the remaining portion of run 1929. Run 2123 corresponds to the remaining portion of run 1925, added cell 2107, and run 1931. All of the voxels in set of voxels 2117 are connected to one or more other voxels in the set by their faces.

Edge and Corner Intersections in Sets of 6-Connected Voxels: FIGS. 22-25

With 6-connected sets of voxels that are intersected by a ray, ray-object intersection tests can be avoided if voxels in which the ray intersects only an edge or a corner of the voxel can be excluded from the 6-connected set of voxels. FIG. 22 shows the edge intersection case. First, the edge intersection case must be detected. For an edge intersection to occur in the set of 6-connected voxels intercepted by the ray, a corner intersection must occur in one of the two-dimensional sets of runs. This is shown in FIG. 22, where two-dimensional set of runs 2205 that intersects projection 2201 has a corner intersection 2209 between runs 2207 and 2211, but two-dimensional set of runs 2213 that intersects projection 2203 does not have. In terms of the projections 2201 and 2203, the value of β at point 2209 is 0, while its value at 2218 is greater than 0. The edge intersection appears at 2225. When there is an edge intersection, the voxel corresponding to cell 2220 is not included in set of voxels 2219.

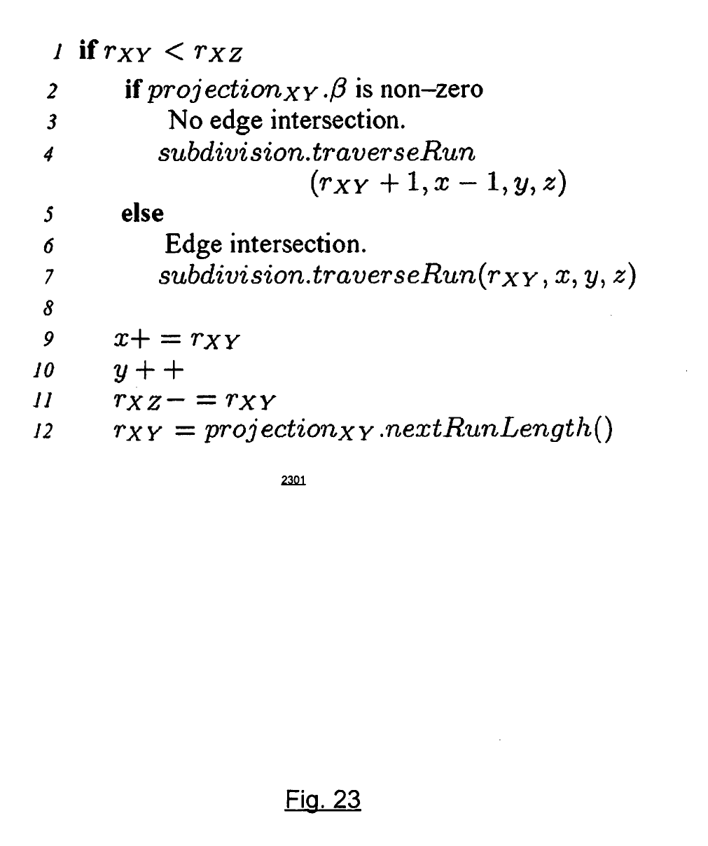

To detect an edge intersection, one proceeds as follows: when making the next run of cells intersected by the projection, the distance 3 between the projection and the corner of the next run is considered. If the distance is non-zero, no edge intersection occurs. If it is zero, an edge intersection occurs and no voxel corresponding to the cell that is added to the beginning of the next two-dimensional run is added to the set of voxels. The algorithm is set forth more precisely at 2301 in FIG. 23, where \hat{β} indicates a normalized value of β

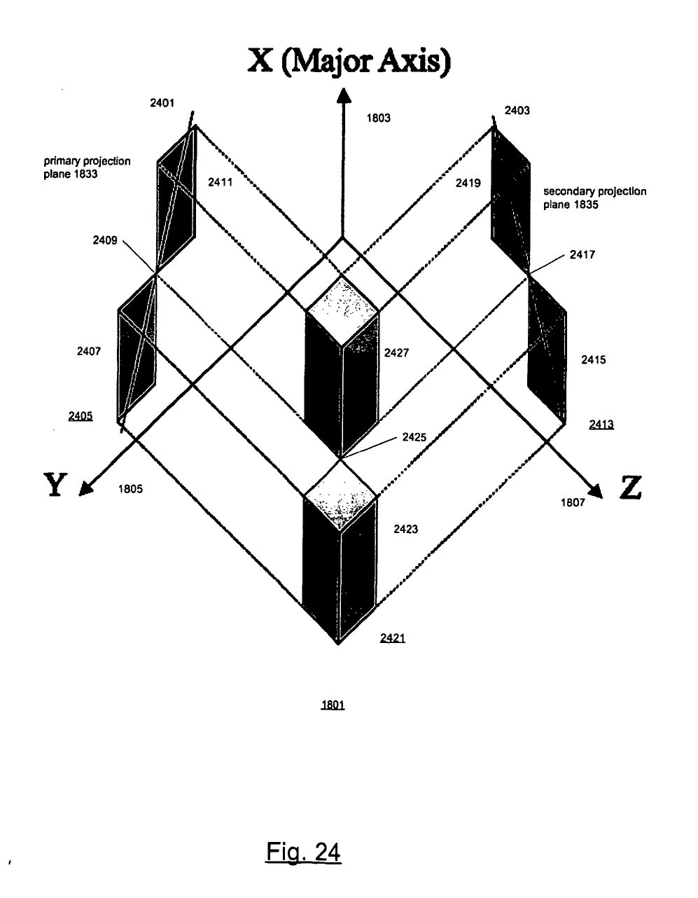

For a corner intersection to occur in the set of voxels, there must be an edge intersection at the same place in the sets of cells that intersect the projections in planes 1833 and 1835. Therefore, a corner intersection in the set of voxels can only occur when the two projected run lengths are the same length. This is shown in FIG. 24. Projected lines 2401 and 2403 produce sets of two-dimensional runs 2405 and 2413 in which runs 2407 and 2415 are the same length and for which δ for the next run is 0. This results in corner intersections 2409 and 2417. Set of voxels 2421 then has a run of voxels 2423 that corresponds to two-dimensional runs 2407 and 2415 and a run of voxels 2427 that corresponds to two-dimensional runs 2411 and 2419. Runs of voxels 2427 and 2423 are connected at corner 2425.

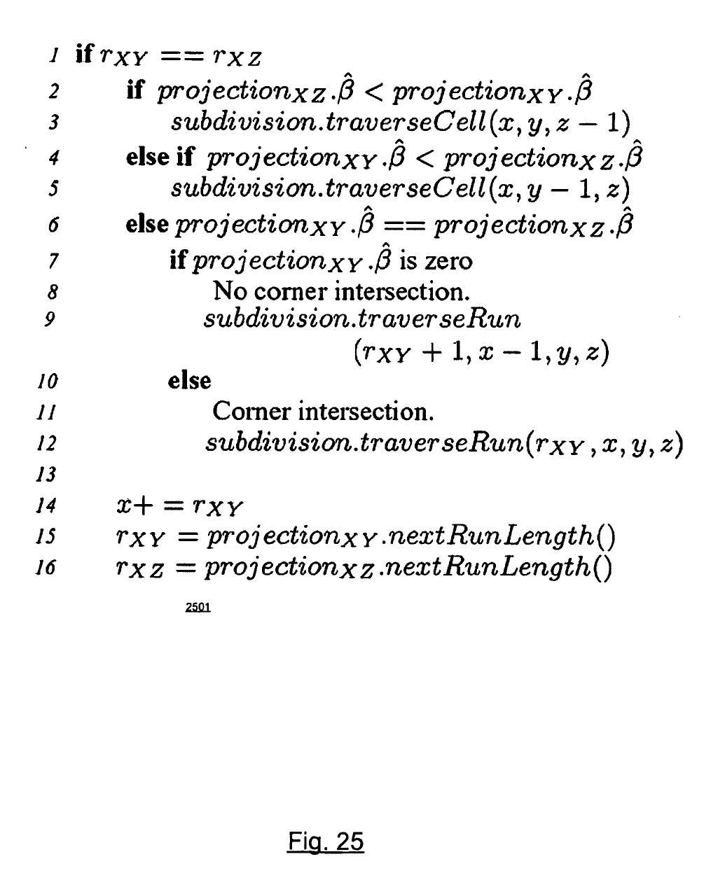

To detect runs of voxels that are connected at a corner, one proceeds as follows: If no edge intersection occurs, to get from the end of the previous run of voxels (x′, y, z) to the start of the next run (x′, y+1, z+1), the ray must intersect the voxel (x′, y+1, z) or (x′, y, z+1) as shown in FIG. 22. Which cell can be determined from the relative value of the normalized intercept values \hat{β} as described in algorithm 2501 of FIG. 25. In this algorithm, the position of the run has already been updated to the start of the next run. Therefore, the voxel intersected by the ray must be handled in retrospect once a corner intersection has been identified.

Efficiency of Computing Voxels Intersected by a Line from Two-Dimensional Runs of Cells Intersected by Projections of the Line

The three-dimensional traversal algorithm requires two separate two-dimensional traversals of each of the projections of the line perpendicular to the major axis. If corner and edge intersections are ignored, the number of runs in the three-dimensional path of the ray is the sum of the number of runs in the two two-dimensional traversals. Therefore the order of the three-dimensional ray traversal algorithm is O(n/τ), where τ is now the average length in the three-dimensional path of the ray and n is the associated number of cells.

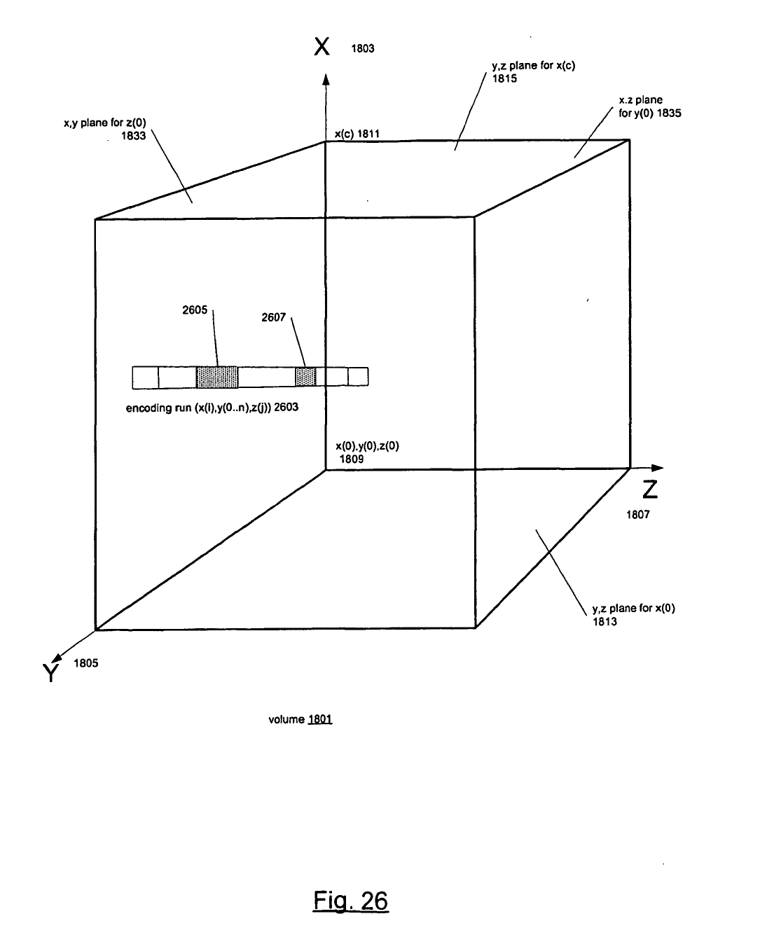

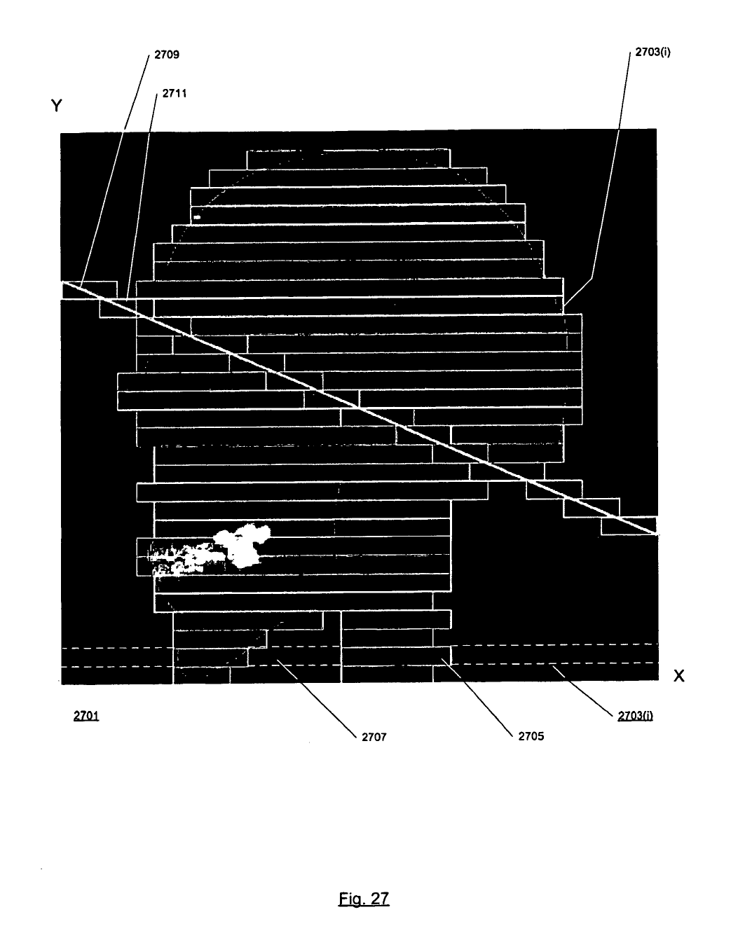

Using Descriptions of Rays as Sets of Runs of Voxels to Accelerate Ray Traversal: FIGS. 26-31

Using Encoding Runs to Describe the Voxels in a Volume: FIG. 26

A problem in rendering the contents of a volume as pixels by traversing the volume with rays to obtain the information needed to define the appearance of the pixels is that in general, not all contained in the volume along the path traversed by a particular ray has anything to do with the appearance of the pixel. Two examples of this fact are the following:
voxels that represent empty space can have no effect on the appearance of the pixel.
once the ray that defines the appearance of the pixel has encountered a voxel that represents an opaque surface, the values of the further voxels traversed by the ray will have no effect on the appearance of the pixel.

The second idea, called early ray termination, only applies to certain rendering functions such as shaded rendering and isosurfaces. If the entire path of the ray through the volume must be determined, as for an X ray style or maximum intensity projection (MIP) rendering, early ray termination is not valid.

A general solution to the problem of skipping uninteresting space is to find some way of indicating that the content of a particular set of voxels will have no effect on a traversing ray. The technique generally used is to subdivide the space being traversed into regions that will affect a traversing ray and regions that will not. When the ray enters a region that does not affect it, there is no need to examine individual voxels in the region.

The technique used to subdivide the space into regions in a preferred embodiment is similar to the compression technique termed run-length encoding. Run-length encoding is used in situations where the data being compressed includes sequences of data in which the same value is repeated over and over again. Such a sequence of data may then be represented by giving the value and the number of repetitions. For example, the sequence of 10 eights, 8888888888 may be encoded as the pair {value, number of occurrences}, or {8,10}. The compressed data thus becomes a list of pairs {value, number of occurrences}. When the sequence of data represents pixels in an image, there may be a list of pairs corresponding to each row of pixels in the image. A row of pixels is of course a run, and in the following, runs used for encoding will be termed encoding runs, to distinguish them from the runs of cells traversed by a line or ray.

Similarly, when the sequence of data represents voxels in a volume, the encoding runs may be rows of voxels in the volume. FIG. 26 gives an example of an encoding run 2603 in volume 1801. Encoding run 2603 is a row of voxels in 1801 for which the coordinates are (x(i),y(0 . . . n),z(j)). Similar encoding runs may of course be made where the voxels all have the same y and z coordinates and a range of x coordinates or the same x and y coordinates and a range of z coordinates. The best encoding runs to use with a particular ray are those for which the dimension with the range of coordinates is the dimension of the major axis of the ray. In encoding run 2603, there are only two areas 2605 and 2607 in which the contents of the voxels will affect a ray that traverses the voxel. Encoding run 2603 can thus be encoded as a list of sets of three values as follows: {NULL,y(0),y(a)}; {VAL1, (y(b),y(b)}; {NULL,y(c),y(d)}; {VAL2, (y(e),y(f)}; {NULL,y(g),y(h)}, where a part of the run that has no effect on the ray is indicated by NULL followed by the y coordinates of the beginning and end of the sequence of voxels that have no effect and a part of the run that can affect a ray is indicated in the same way, except that NULL is replaced by value(s) that will affect the ray in the sequence.

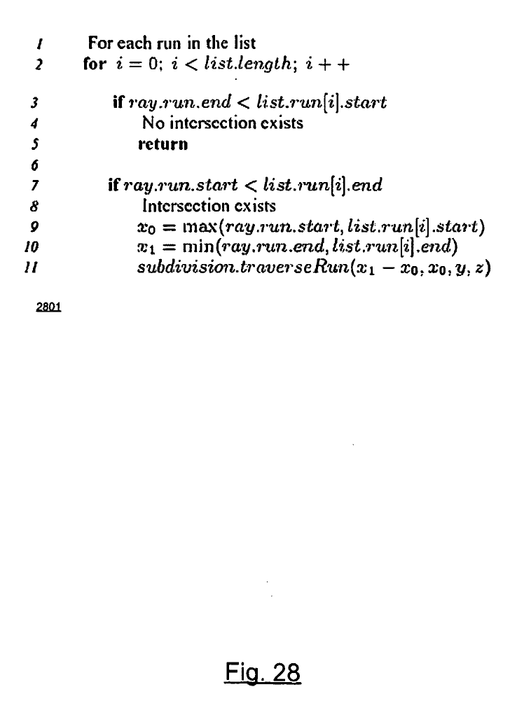

Using Runs of Voxels Traversed by a Ray Together with Encoding Runs to Accelerate Ray Traversal: FIGS. 27-30

If lists of encoding runs 2603 have been made for each of the principle axes of a volume, then the problem of determining how a ray is affected by the voxels of the volume can be solved by determining whether there are any voxels traversed by the ray (termed in the following ray voxels) in the list of encoding runs for the ray's major axis that are the same as voxels which the list of encoding runs indicate will affect the ray. These later voxels belong to what will be termed in the following significant runs of the encoding run. If there are ray voxels that are the same as voxels in a significant run, the data items corresponding to the voxels in the significant run that match the ray voxels must be examined to determine how they affect the ray. Using the techniques just explained to determine the ray voxels for a ray make determining whether there are ray voxels that are the same as voxels in a significant run in a particular encoding run easier, since in order for there to be such voxels, a run of the ray voxels must intersect the significant run. Further, as already described, the projections of the ray may be described using runs of orders greater than 1, and the runs of ray voxels may be thus made of any useful length. In general, of course, the emptier the volume is, the more acceleration results from the use of longer runs of ray voxels.

How the ray voxels intersect significant runs is shown in FIG. 27. FIG. 27 shows a slice 2701 of a volume of voxels in which the voxels are associated with data from the Visible Human Project male dataset. The data describes the head and neck of a human male. Slice 2701 is a set of voxels that have the full range of x and y coordinates permitted by the volume and a single z coordinate. The interesting region of slice 2701 is represented as a list of encoding runs. The run of voxels represented by one such run, 2703(1), is shown in FIG. 27. As shown there, run 2703(i) has three runs 2707 that contain no information that will affect a ray and two significant runs 2705; the encoding run corresponding to run of voxels 2703(i) will represent that fact as described above. A single ray 2709 is shown traversing the volume. The ray has the X-axis as its major axis; consequently, the encoding runs of interest are those for the X-axis. The ray is further parallel to the z-axis, and is thus completely contained in the encoding runs of slice 2701 throughout its traverse of the volume. The techniques described here can also be used in the case where the ray intersects more than one slice. Ray 2709 intersects a set of runs of ray voxels; one of the runs of ray voxels is shown at 2711; this run also intersects an encoding run 2703(1) whose voxels contain information that will affect ray 2709.

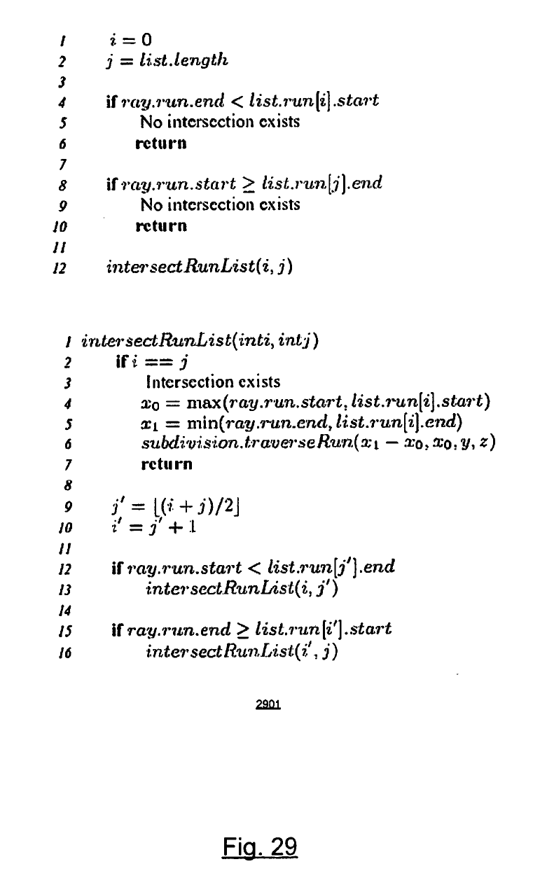

The problem of finding an intersection between ray 2709 and a significant run 2705 of an encoding run 2703 can be solved by detecting any intersection between the run from the ray and a significant run in the list of runs associated with the encoding run. Given that the list of significant runs from the encoding run is ordered, the search can be performed efficiently and a number of strategies are possible. The simplest is described in algorithm 2801 of FIG. 28. For each run of ray voxels belonging to the ray, if the end of the run of ray voxels is before the start of the significant run being checked, there is no ray voxel in the run which is identical with a voxel of the significant run and a failing result can be returned for that run of ray voxels. On the other hand, if the start of the run of ray voxels is before the end of the significant run being considered, an intersection has occurred and the voxels of the significant run that also belong to the run of ray voxels must be considered in detail. In algorithm 2801, a linear search is used to locate the intersecting ray voxels and significant run voxels. As shown in algorithm 2901 in FIG. 29, once it has been determined that there is an intersection, binary search techniques can be used to determine the intersecting ray voxels and significant run voxels

Using Statistical Information about a Significant Portion of an Encoding run to Accelerate a Ray Traversal

Further acceleration of ray traversal may be achieved by hierarchically grouping encoding runs that lie in the same or adjacent beams of the volume data. A beam is the maximum set of voxels in a slice with the same abscissa or ordinate. Therefore, voxels are arranged into beams, beams are arranged into slices, and slices are arranged into the volume. If the encoding run has already been divided into significant runs, aggregate information may be maintained about each significant run. For example, for a maximum intensity projection (MIP) rendering of a volumetric data set, storing the maximum value found within each significant run would be useful. For a MIP rendering, as the ray intersects a significant run, the maximum value of the run can be compared against the current maximum for the ray. If the ray is already at or above the maximum intensity, there is no need to consider the voxels in the significant run in detail. In many cases, including such statistical information about the run dramatically reduces the number of times the original data set has to be accessed. The use of aggregate information as just described establishes a hierarchy of information concerning the encoding run and permits each partition of an encoding run to be checked in its entirety for relevance to the ray before the intersecting voxels of the ray and the significant run are checked in detail.

Another example is isosurface rendering in which the surface that corresponds to a given value is reconstructed from the volumetric data. To reconstruct an isosurface using ray-tracing, each ray is traced through the volume and where it would cross the isosurface is calculated. Therefore if the viewer is external to the volume and the exterior of the volume is assumed to be empty space, the voxel in which one of its neighboring values is greater than the isosurface value is sought. Within this voxel, the ray may cross the isosurface, and if so, the point of the intersection must be calculated. To quickly skip over regions of the volume in which no isosurface intersection can exist, the minimum and maximum values found within each significant run can be kept. These values can be used to determine if an isosurface intersection can exist in any composite voxel. If not, the entire significant can be skipped.

Efficiency of Run-Length Encoding of Voxels

A three-dimensional run length encoding of a volume provides an O(kn²) compression of the volumetric data where k is proportional to the mean number of significant runs in the encoding run lists and n³ is the size of the volume. Such runs are termed in the following significant runs. The maximum number of significant runs in list cannot exceed n/2 by definition. To traverse the run length encoding of the volume using the run-based ray traversal scheme, each run in the path of the ray is intersected with the significant runs in the encoded run list. As it was implemented, the searching strategy is an O(k) operation. The procedure in its entirety is therefore O(n/τ+k). Hence at its worst the behavior of the algorithm is O(n) when the absolute value of the slope of the two two-dimensional projections of the ray is 1. Typically the behavior will be O(n/τ) as k will typically be much less than n/2.

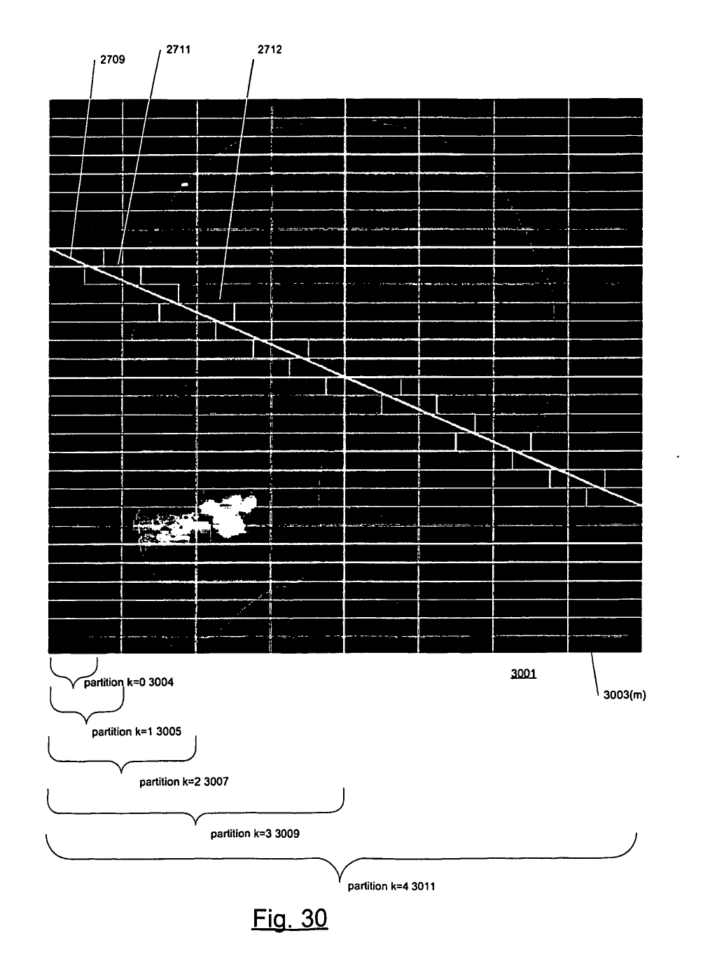

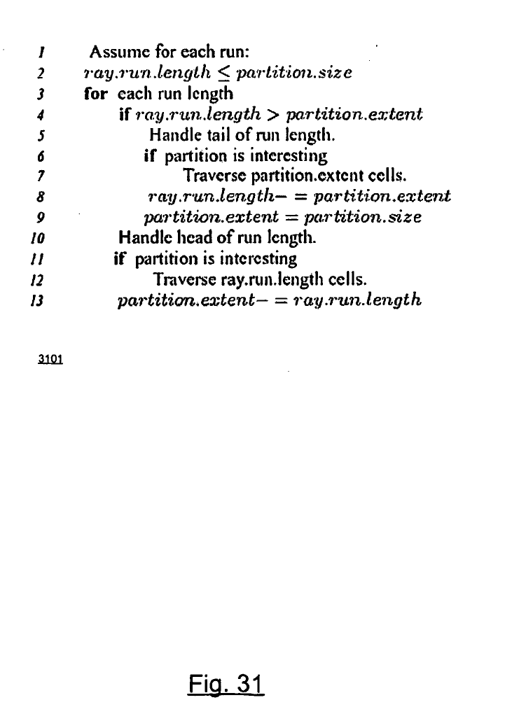

Organizing an Encoding run into Sets of Partitions of Various Sizes: FIGS. 30 and 31

The three-dimensional ray traversal algorithm described is very efficient and for most of the rendering functions employed, such as isosurfacing and maximum intensity projection, the cost to process each voxel traversed by the ray is not high. The aim of using spatial subdivisions to accelerate the traversal process is to reduce the amount of the volume that has to be processed and to concentrate the processing performed to that part of the volume that affects the final image. However, if traversing the ray through the spatial subdivision introduces too much overhead, its contribution is limited.

Since only encoding voxels that are intersected by a run of ray voxels belonging to a particular ray are of interest for the ray's traversal, it is useful to divide the encoding runs into sets of partitions of different sizes. Aggregate information for each partition is maintained, and when a ray traverses a volume, the size of partition that best fits the orientation of the ray is employed.

This is shown in FIG. 30. Shown at 3001 is again a slice of a volume of voxels in which the voxels are associated with data from the Visible Human Project male data set. The data describes the head and neck of a human male. Slice 3001 is a set of voxels that have the fill range of x and y coordinates permitted by the volume and a single z coordinate. Ray 2709 intersects slice 3001. The voxels of ray 2709 occur in runs of two lengths: a short run of 3 voxels is shown at 2711 and a long run of four voxels is shown at 2612. The encoding runs 3003 have been divided into run length partitions. The partitions 3005 at the lowest level of the hierarchy each have 4 voxels; each higher-level partition in the hierarchy would contain a greater number of voxels than the previous level. In FIG. 30, the increase in size is based on the powers of two. A partition at a given level k of the hierarchy contains 2^{k} of the lowest-level partitions. Thus, in FIG. 30, partition 3005 contains four voxels, partition 3007 contains two partitions 3005 and therefore 8 voxels, and so forth for 1≦k≦4. While the partitions of the hierarchy can be related to each other in other ways, use of the powers of 2 makes it easy to calculate the partition sizes.

Ray 2709 has runs of 3 and 4 voxels; consequently, the best size of partition to use for ray 2709's traversal of slice 3001 is partition 3005. Once the proper partition size has been selected, the algorithm is as shown at 3101 in FIG. 31. There are two cases: if the portion of the ray run being processed extends beyond the partition and if it does not. In the first case, the partition's aggregate data is consulted to determine whether the partition is relevant to the ray; if it is, the voxels of interest in the partition are traversed. Thereupon, the length of the ray run is decreased by the number of intersecting voxels, and the partition indicator is set to the next partition. In the second case, the partition's aggregate data is again consulted to determine whether the partition is relevant; if it is, the voxels of interest in the partition are traversed. Thereupon, the amount of the partition to be processed is reduced by the length of the ray run.

Given the run-based ray traversal algorithm, the problem is therefore how best to traverse the ray through the run length partitioning and what is the best partition size to use. If the average length of a ray run is a lot smaller than the size of the partition, there will be little gain, as the aggregate statistics associated with the partition represent the entire partition and the number of ray runs that will be rejected is reduced. Further, if the partition size is much larger than the ray run, the cost and complexity of checking for significant runs in the partition is greater. Therefore, the cost of traversing the partitioning must be balanced with the savings from finding voxels that need not be considered. If dealing with voxels that are relevant to the ray is expensive, it is better to use a small partition size. If that is not the case, a larger partition size can permit a faster traversal algorithm.

A good compromise is to choose a run-length-partition size that is at least as large as the short run length in the path of the ray, as was done when a partition size of 4 was chosen in FIG. 30. In this case, the ray at each step will traverse at most two partitions. Therefore, the loop to traverse the run through the partitions can be unrolled into a two-stage process, as is done in algorithm 3101.

Efficiency of Ray Traversal with a Partitioned Hierarchy of Runs

A three-dimensional run length partitioning of a volume provides an O(n³/p) compression of the volumetric data where p is the partition size and n³ is the size of the volume. To test a run against a partitioning, at most |(rⱼ −1)/p |+1 partition checks must be performed. The order of the ray traversal algorithm is O(n/τ), where τ is the average run length in the path of the ray. Therefore the ray traversal process through the partitioning is O(n/min(p, τ)). By choosing τ to be less than or equal to the partition size, the complexity of O(n/τ) is maintained for the entire traversal process.

### Conclusion

The foregoing Detailed Description has disclosed how to use the inventor's techniques for determining the voxels that are intersected by a ray using runs of cells that are intersected by projections of the ray on planes and for determining whether a ray intersects a voxel whose associated data will affect the ray and has further disclosed the best mode known to the inventor of practicing his techniques. It will, however, be immediately apparent to those skilled in the relevant technologies that many other ways of practicing the techniques are possible. For example, the techniques used to determine the cells of the planes that are intersected by the projections are those described in the parents of the present application; however, any other way of determining the cells that are intersected by the projections could be used as well. Similarly, any technique of determining the intersected voxels from the intersected cells could be used in addition to those disclosed herein. With regard to the techniques for determining whether a ray run traverses a voxel of an encoding run that affects the ray, any method of encoding that distinguishes significant runs from the remainder of the encoding run may be used, and aggregate values may be maintained for any useful partition of the encoding runs. Finally, any useful representation of the runs of cells, the runs of voxels, and the encoding runs may be employed.

Since that is the case, the Detailed Description is to be regarded as being in all respects exemplary and not restrictive, and the breadth of the invention disclosed herein is to be determined not from the Detailed Description, but rather from the claims as interpreted with the full breadth permitted by the patent laws.

1. A method practiced in a computer system of determining voxels in an object space that are intersected by a ray,
the method comprising the steps of:
making projections of the ray on a plurality of planes in the object space;
determining cells in the planes that are intersected by the projections; and
using the intersected cells to determine the intersected voxels.

2. The method set forth in claim 1 wherein the step of determining cells in the planes includes the step of:
for each projection determining a set of runs of cells that are intersected by the projection.

3. The method set forth in claim 2 wherein:
the runs may have an order greater than 1.

4. the method set forth in claim 2 wherein:
the object space has an axis that is the major axis relative to the ray; and
in the step of using the intersected cells,
at the beginning of the next run of voxels,
if the first-order runs of cells that include the points in the projections corresponding to the beginning of the next run of voxels end at the same major axis coordinate, the first-order runs of cells together determine the next run of voxels through the ends of the first-order runs; and
if the first order runs of cells that include the points in the projections corresponding to the beginning of the next run of voxels do not end at the same major axis coordinate, the shorter first order run of cells and the corresponding portion of the longer of the first order runs of cells determine the next run of voxels,
whereby the voxels intersected by the ray are 26-connected.

5. The method set forth in claim 4 wherein:
in the step of using the intersected cells, an extra cell is added to the beginning of a first order run of cells prior to using the first order run of cells to determine a run of voxels, whereby the voxels intersected by the ray are 6-connected.

6. The method set forth in claim 2 wherein:
in the step of determining a set of runs, the set of runs for a given projection are determined in parallel.

7. The method set forth in claim 2 wherein:
the step of using the intersected cells to determine the intersected voxels further includes the step of determining whether the intersected voxels are edge-connected or corner-connected.

8. The method set forth in claim 7 wherein:
in the step of determining whether the intersected voxels are edge-connected or corner connected,
if one of the first-order runs of cells has a corner connection at a point and the other first order run of cells does not have a corner connection at the corresponding point, the intersected voxels have an edge connection at the corresponding point.

9. The method set forth in claim 7 wherein:
in the step of determining whether the intersected voxels are edge-connected or corner connected,
if both of the first-order runs of cells have corner connections at a corresponding point, the intersected voxels have a corner connection at the corresponding point.

10. The method set forth in claim 1 wherein:
the object space has an axis that is the major axis relative to the ray; and
the plurality of planes is two planes which intersect along the major axis.

11. The method set forth in claim 10 wherein:
the two planes intersect at right angles.

12. A method practiced in a computer system of traversing a volume with a particular ray of a plurality thereof, the volume being subdivided into first runs of voxels, certain of the voxels being associated with data that affects rays, and a ray intersecting one or more of the first runs and being defined as a set of second runs of voxels, and the method comprising the steps of:
for a second run belonging to the particular ray, determining whether the second run includes a voxel of a first run that affects rays; and
when the second run includes such a voxel, examining the associated data.

13. The method set forth in claim 12 wherein the first runs contain significant runs that include the certain voxels; and
the step of determining whether the particular ray's second run includes a voxel of a first run that affects rays includes determining whether the second run includes a voxel of a significant run.

14. The method set forth in claim 12 wherein:
the volume has an axis that is the major axis for both the particular ray and the first runs of voxels.

15. The method set forth in claim 14 wherein:
there are three sets of first runs, each set thereof having a different axis of the volume as its major axis.

16. The method set forth in claim 12 wherein:
aggregate information is associated with partitions of the first runs, the aggregate information associated with a partition indicating how one or more voxels in the partition affect rays; and
in the step of determining whether second run includes a voxel of a first run that affects rays, the aggregate information associated with a partition is used to determine whether the partition contains a voxel that affects the particular ray.

17. The method set forth in claim 16 wherein:
a first run has associated therewith a plurality of sets of partitions, the partitions in each set having a different length in voxels; and
the step of determining includes the step of selecting one of the sets of partitions in accordance with the lengths of the second runs in the particular ray.

18. The method set forth in claim 13 wherein:
aggregate information is associated with the significant runs, the aggregate information associated with the significant run indicating how one or more voxels in the partition affect rays; and
the step of determining whether second run includes a voxel of a first run that affects rays includes using the aggregate information associated with a significant run to determine whether the significant run contains a voxel that affects the particular ray.
